(19) United States
(12) Patent Application Publication
(10) Pub. No.: US 2026/0118625 A1
(43) Pub. Date: Apr. 30, 2026

(54) IMAGING LENS, CAMERA MODULE AND ELECTRONIC DEVICE

(71) Applicant: LARGAN INDUSTRIAL OPTICS CO., LTD., Taichung City (TW)

(72) Inventors: Hsuan-Chin HUANG, Taichung City (TW); Yu Chen LAI, Taichung City (TW); Wei Chih CHEN, Taichung City (TW)

(73) Assignee: LARGAN INDUSTRIAL OPTICS CO., LTD., Taichung City (TW)

(21) Appl. No.: 19/281,861

(22) Filed: Jul. 28, 2025

Related U.S. Application Data
(60) Provisional application No. 63/712,329, filed on Oct. 25, 2024.

(30) Foreign Application Priority Data
Apr. 18, 2025 (TW) 114114788

(51) Int. Cl. G02B 7/02

(52) U.S. Cl. CPC G02B 7/026

(57) ABSTRACT

An imaging lens includes a lens element, a lens barrel, an arm, a holder and a retainer. The lens element has an optical axis. The lens barrel accommodates the lens element. The arm is disposed on the lens barrel and extends along a direction away from the optical axis. The holder has a first contacting surface in contact with the arm in a direction parallel to the optical axis. The retainer is fixed on the holder and has a second contacting surface in contact with the arm in a direction parallel to the optical axis. The first contacting surface and the second contacting surface are located on opposite sides. The arm is disposed between the holder and the retainer. The first contacting surface and the second contacting surface surround the optical axis and are non-overlapped with each other in a direction parallel to the optical axis.

### RELATED APPLICATIONS

This application claims priority to U.S. Provisional Application 63/712,329, filed on Oct. 25, 2024 and Taiwan Application 114114788, filed on Apr. 18, 2025, which are incorporated by reference herein in its entirety.

### BACKGROUND

### Technical Field

The present disclosure relates to an imaging lens, a camera module and an electronic device, more particularly to an imaging lens applicable to a camera module and an electronic device.

### Description of Related Art

With the development of technology, featuring high image quality becomes one of the indispensable features of an optical system nowadays. Furthermore, electronic devices equipped with optical systems are trending towards multi-functionality for various applications, and therefore the functionality requirements for the optical systems have been increasing.

However, conventional optical lenses are difficult to meet the requirements of high optical quality of an electronic device under diversified development in recent years, particularly in terms of dimensional accuracy tolerance to ambient temperature variations in the market of the current technology trends. Therefore, how to improve the mechanism employed for moving an optical lens to meet the stringent requirements of high-end-specification electronic devices is an important topic in this field nowadays.

### SUMMARY

According to one aspect of the present disclosure, an imaging lens includes at least one lens element, a lens barrel, an arm, a holder and a retainer. The at least one lens element has an optical axis. The lens barrel accommodates the at least one lens element. The arm is disposed on a side of the lens barrel away from the optical axis, and the arm extends along a direction away from the optical axis. The holder has a first contacting surface overlapped with and in contact with the arm in a direction parallel to the optical axis. The retainer is fixed on the holder, and the retainer has a second contacting surface overlapped with and in contact with the arm in a direction parallel to the optical axis. The second contacting surface is located on an opposite side of the first contacting surface. The arm is disposed between the holder and the retainer. The holder and the retainer are made of different materials. The first contacting surface and the second contacting surface surround the optical axis and are non-overlapped with each other in a direction parallel to the optical axis. When a coefficient of thermal expansion of the holder is α-holder, and a coefficient of thermal expansion of the retainer is α-retainer, the following condition is satisfied: α-retainer<α-holder. When a distance between the optical axis and a side of the first contacting surface close to the second contacting surface is D-1tocenter, and a distance between the optical axis and a side of the second contacting surface close to the first contacting surface is D-2tocenter, the following condition is satisfied: 0.05 mm≤|D-1tocenter−D-2tocenter|≤1.8 mm.

According to another aspect of the present disclosure, a camera module includes the aforementioned imaging lens and an image sensing assembly. The image sensing assembly includes an image sensor disposed on an image side of the imaging lens. The holder of the imaging lens is fixed to the image sensing assembly.

According to another aspect of the present disclosure, a camera module includes a lens assembly, a lens barrel, an arm, an image sensor, a holder and a retainer. The lens assembly has a plurality of lens elements disposed along an optical axis. The lens barrel carries the lens assembly. The arm extends from the lens barrel along a direction away from the optical axis. The image sensor is disposed on an image side of the lens assembly. The holder is configured for the lens barrel to be disposed thereon so as to correspond the lens barrel to the image sensor, and the holder has a first contacting surface surrounding the optical axis and being in contact with the arm. The retainer is fixed on the holder so as to fix the lens barrel to the holder, and the retainer has a second contacting surface surrounding the optical axis and being in contact with the arm so as to keep the arm in constant contact with the first contacting surface. The arm is disposed between the holder and the retainer. One of the arm, the holder and the retainer is made of a material different from that of the other two of the arm, the holder and the retainer. The first contacting surface and the second contacting surface are non-overlapped with each other in a direction parallel to the optical axis. When a distance between the optical axis and a side of the first contacting surface close to the second contacting surface is D-1tocenter, and a distance between the optical axis and a side of the second contacting surface close to the first contacting surface is D-2tocenter, the following condition is satisfied: 0.05 mm≤|D-1tocenter−D-2tocenter|≤1.8 mm.

According to another aspect of the present disclosure, a camera module includes a lens assembly, a lens barrel, an arm, an image sensor, a holder and a retainer. The lens assembly has a plurality of lens elements disposed along an optical axis. The lens barrel carries the lens assembly. The arm extends from the lens barrel along a direction away from the optical axis. The image sensor is disposed on an image side of the lens assembly. The holder is configured for the lens barrel to be disposed thereon so as to correspond the lens barrel to the image sensor. The holder includes a base and a holder carrier disposed on the base. The holder carrier has a first contacting surface surrounding the optical axis and in contact with the arm, and the holder carrier carries the lens barrel through the first contacting surface. The retainer is fixed on the holder so as to fix the lens barrel to the holder, and the retainer has a second contacting surface and a mounting portion. The second contacting surface surrounds the optical axis and is in contact with the arm. The retainer is mounted on the base through the mounting portion. The arm is disposed between the holder and the retainer. One of the arm, the holder and the retainer is made of a material different from that of the other two of the arm, the holder and the retainer. The first contacting surface and the second contacting surface are non-overlapped with each other in a direction parallel to the optical axis.

According to another aspect of the present disclosure, a camera module includes a plurality of lens elements, a lens barrel, an arm, an image sensor, a holder and a retainer. The lens elements are disposed along an optical axis. The lens barrel has a cylindrical wall surrounding the lens elements. The arm extends from the cylindrical wall of the lens barrel along a direction away from the optical axis, and the arm has an arm top surface facing towards an object side and an arm bottom surface facing towards an image side. The image sensor is disposed on an image side of the lens barrel. The holder is configured for the lens barrel to be disposed thereon. The holder includes a base and a holder carrier. The base has a bottom portion and a surrounding wall. The bottom portion has a bottom surface facing towards the arm. The surrounding wall extends from the bottom surface of the bottom portion towards the arm, and the surrounding wall has a surrounding top surface facing towards the arm and a surrounding inner surface facing towards the lens barrel. The holder carrier is connected to the base. The holder carrier has a strengthening element and an extension portion. The strengthening element includes a first abutting portion, a connecting portion and a second abutting portion. The first abutting portion abuts on the surrounding top surface. The connecting portion extends from the first abutting portion along a direction away from the arm. The second abutting portion is connected to the connecting portion, and the second abutting portion is located further away from the arm than the first abutting portion. The extension portion has a first end connected to the second abutting portion and a second end extending from the first end towards the arm. The second end is in contact with the arm bottom surface and forms a first contacting surface. The retainer is fixed on the holder, and the retainer abuts on the arm top surface and forms a second contacting surface. When a length of the surrounding inner surface along a direction parallel to the optical axis is L-toruinsidesurface, and a length of the bottom surface along a direction parallel to the optical axis is L-downsidesurface, the following condition is satisfied: L-toruinsidesurface>L-downsidesurface.

According to another aspect of the present disclosure, an electronic device includes one of the aforementioned camera modules.

### BRIEF DESCRIPTION OF THE DRAWINGS

The disclosure can be better understood by reading the following detailed description of the embodiments, with reference made to the accompanying drawings as follows:

FIG. 1 is a cross-sectional view of an imaging lens according to the 1st embodiment of the present disclosure;

FIG. 2 is an enlarged view of AA region of the imaging lens of FIG. 1;

FIG. 3 is an enlarged view of BB region of the imaging lens of FIG. 1;

FIG. 4 is a cross-sectional view of an imaging lens according to the 2nd embodiment of the present disclosure;

FIG. 5 is an enlarged view of CC region of the imaging lens of FIG. 4;

FIG. 6 is a cross-sectional view of an imaging lens according to the 3rd embodiment of the present disclosure;

FIG. 7 is an enlarged view of DD region of the imaging lens of FIG. 6;

FIG. 8 is a cross-sectional view of an imaging lens according to the 4th embodiment of the present disclosure;

FIG. 9 is an enlarged view of EE region of the imaging lens of FIG. 8;

FIG. 10 is a cross-sectional view of an imaging lens according to the 5th embodiment of the present disclosure;

FIG. 11 is an enlarged view of FF region of the imaging lens of FIG. 10;

FIG. 12 is a cross-sectional view of an imaging lens according to the 6th embodiment of the present disclosure;

FIG. 13 is an enlarged view of GG region of the imaging lens of FIG. 12;

FIG. 14 is a schematic view showing arrangement correspondence of elements of the imaging lens of FIG. 12;

FIG. 15 is a schematic view showing arrangement correspondence of another elements of the imaging lens of FIG. 12;

FIG. 16 is a schematic view showing arrangement correspondence of elements of an imaging lens according to the 7th embodiment of the present disclosure;

FIG. 17 is a schematic view showing arrangement correspondence of another elements of the imaging lens of FIG. 16;

FIG. 18 is a cross-sectional view of an imaging lens according to the 8th embodiment of the present disclosure;

FIG. 19 is an enlarged view of HH region of the imaging lens of FIG. 18;

FIG. 20 is an exploded view of the imaging lens of FIG. 18;

FIG. 21 is another exploded view of the imaging lens of FIG. 18;

FIG. 22 is a schematic view showing arrangement correspondence of elements of an imaging lens according to the 9th embodiment of the present disclosure;

FIG. 23 is a schematic view showing arrangement correspondence of another elements of the imaging lens of FIG. 22;

FIG. 24 is a perspective view of an electronic device according to the 10th embodiment of the present disclosure;

FIG. 25 is a perspective view of an electronic device according to the 11th embodiment of the present disclosure;

FIG. 26 is another perspective view of the electronic device in FIG. 25;

FIG. 27 is an illustration of an image captured by an ultra-wide-angle camera module;

FIG. 28 is an illustration of an image captured by a high pixel camera module;

FIG. 29 is an illustration of an image captured by a telephoto camera module;

FIG. 30 is a perspective view of an electronic device according to the 12th embodiment of the present disclosure;

FIG. 31 is a perspective view of an electronic device according to the 13th embodiment of the present disclosure;

FIG. 32 is a side view of the electronic device in FIG. 31; and

FIG. 33 is a top view of the electronic device in FIG. 31.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A camera module provided in the present disclosure includes an imaging lens and an image sensing assembly.

The imaging lens includes at least one lens element, a lens barrel, an arm, a holder and a retainer. The quantity of the at least one lens element can be plural, and the plurality of lens elements form a lens assembly.

The at least one lens element has an optical axis. The at least one lens element is arranged along the optical axis. The lens barrel accommodates (or carries) the at least one lens element. Moreover, the at least one lens element can include a plastic lens element and a glass lens element. Therefore, it is favorable for improving optical quality and reducing environmental impacts on the imaging lens. Moreover, the glass lens element can have a relatively low coefficient of thermal expansion, allowing the glass lens element to maintain optical quality despite environmental variations. In one aspect of the present disclosure, the lens barrel can have a cylindrical wall surrounding the at least one lens element.

The arm is disposed on a side of the lens barrel away from the optical axis. Moreover, the arm can be disposed on the side of the lens barrel away from the optical axis through any suitable fixture means such as screwing, structural mounting, adhesive dispensing and welding. Alternatively, the arm can be integrally formed with the lens barrel so as to prevent assembly misalignment of the arm and thus to increase yield rate, which can also increase structural strength between the arm and the lens barrel and simplify manufacturing processes. However, the present disclosure is not limited to any particular fixture means between the arm and the lens barrel. The arm extends from the lens barrel along a direction away from the optical axis. Moreover, in the aspect where the lens barrel has the cylindrical wall, the arm can extend from the cylindrical wall of the lens barrel along a direction away from the optical axis. Moreover, a distance between the arm and an object end of the lens barrel can be less than a distance between the arm and an image end of the lens barrel. Therefore, it is favorable for reducing the height of the imaging lens, thereby miniaturizing the camera module. By doing so, it is favorable for arranging the arm at a position close to the object end, allowing sufficient space at an image side of the arm for arranging the holder with a sufficient length. Moreover, the sufficient length of the holder can provide a good expansion effect. Moreover, the arm can have an arm top surface facing towards an object side and an arm bottom surface facing towards an image side.

The holder is fixed to the image sensing assembly. Therefore, it is favorable for spacing the imaging lens apart from the image sensor and reducing assembly tolerance between the imaging lens and the image sensing assembly, thereby enhancing optical image stability. Moreover, the holder can be fixed on the image sensing assembly through any suitable fixture means such as screwing, structural mounting, adhesive dispensing and welding. However, the present disclosure is not limited to any particular fixture means between the holder and the imaging sensing assembly. Moreover, the holder can be configured for the lens barrel to be disposed thereon so as to correspond the lens barrel to the image sensor. Moreover, the lens barrel can be fixed on the holder. The holder has a first contacting surface overlapped with and in contact with the arm in a direction parallel to the optical axis.

Specifically, the holder can include a base and a holder carrier. The base has a bottom portion and a surrounding wall. The bottom portion has a bottom surface facing towards the arm. The surrounding wall extends from the bottom surface of the bottom portion towards the arm, and the surrounding wall has a surrounding top surface facing towards the arm and a surrounding inner surface facing towards the lens barrel. The holder carrier is disposed on (or connected to) the base. The holder carrier has the abovementioned first contacting surface and a third contacting surface. The holder carrier carries the lens barrel through the first contacting surface. The holder carrier is in contact with the base through the third contacting surface.

The holder can have a strengthening element and an extension portion. The strengthening element can be overlapped with the first contacting surface in a direction parallel to the optical axis. Therefore, it is favorable for preventing deformation of the holder when an overly large force applied on the first contacting surface. Moreover, the strengthening element can be made of metal material, ceramic material, composite material containing glass fiber material, etc. Moreover, the strengthening element can include a first abutting portion, a connecting portion and a second abutting portion. The first abutting portion abuts on the surrounding top surface. The connecting portion extends from the first abutting portion along a direction away from the arm. The second abutting portion is connected to the connecting portion. The second abutting portion is located further away from the arm than the first abutting portion. Moreover, the strengthening element can be located between the extension portion and the surrounding wall. Therefore, it is favorable for enhancing the structural strength of the first abutting portion and the second abutting portion.

The extension portion has a first end connected to the second abutting portion and a second end extending from the first end towards the arm. The first end is in contact with the strengthening element and forms a fourth contacting surface that can be located further away from the arm than the third contacting surface. The second end is in contact with the arm bottom surface and form the abovementioned first contacting surface. Moreover, the extension portion can be made of plastic material. Moreover, the extension portion has a coefficient of thermal expansion varying with temperature. Moreover, the extension portion is configured to move the first contacting surface of the holder along a direction parallel to the optical axis. Moreover, the holder carrier can have the abovementioned strengthening element and the abovementioned holder.

The retainer is fixed to the holder. Moreover, the retainer can be fixed on the holder through any suitable fixture means such as screwing, structural mounting, adhesive dispensing and welding. Please be noted that in the case of fastening the retainer and the holder by screwing, a specific torque can be applied on the screws to ensure stable attachment and optimal mobility between the retainer and the holder. However, the present disclosure is not limited to any particular fixture means between the retainer and the holder. The retainer has a second contacting surface overlapped with and in contact with the arm in a direction parallel to the optical axis. The second contacting surface is located on an opposite side of the first contacting surface. Moreover, the second contacting surface is configured to keep the arm in constant contact with the first contacting surface. Moreover, the retainer can abut on the arm top surface and form the abovementioned second contacting surface.

In the imaging lens, the arm is disposed between the holder and the retainer, and one of the arm, the holder and the retainer is made of a material different from that of the other two of the arm, the holder and the retainer. Therefore, the arm located on the outer side of the lens barrel is favorable to be bent or deformed in response to temperature variations so as to form a compensation mechanism to counteract thermal effect, thereby maintaining optical quality of the imaging lens across a relatively wide ambient temperature range. Moreover, the holder and the retainer are made of different materials.

In the imaging lens, the first contacting surface and the second contacting surface surround the optical axis and are non-overlapped with each other in a direction parallel to the optical axis. Therefore, it is favorable for taking one of the first contacting surface and the second contacting surface as a fulcrum and taking the arm as a lever, such that the at least one lens element and the lens barrel can be moved by the lever along a direction parallel to the optical axis in response to ambient temperature variations, thereby compensating for thermal effect on the imaging lens. Moreover, the first contacting surface and the second contacting surface can surround the optical axis, for example, in a loop shape, in an arc shape, in a multiple-arc shape, etc. However, the present disclosure is not limited to any particular manner in which the first contacting surface and the second contacting surface surround the optical axis.

With the abovementioned configuration, the different deformation rates of the holder and the retainer due to temperature variations can generate a torque applied on the arm, causing a slight and controlled bending of the arm as ambient temperature varies. This can provide accurate and precise displacement of the at least one lens element and the lens barrel in a direction parallel to the optical axis. Therefore, changes in the back focal length caused by ambient temperature variations can be compensated, enabling the imaging lens to maintain high-quality optical performance.

Please be noted that the lens barrel, the arm, the holder and the retainer can be made of, for example, plastic material, but the present disclosure is not limited thereto.

According the present disclosure, the imaging lens can further include a connector. The connector can be formed on the arm. The connector can surround the optical axis and form a light-passable hole. The light-passable hole can be located at a position where an aperture of the imaging lens is located. Therefore, it is favorable for connecting the holder and the lens barrel through the connector so as to prevent affecting lens element due to bending of the arm, thereby improving optical performance.

According to the present disclosure, the image sensing assembly of the camera module includes an image sensor disposed on the image side of the imaging lens. Moreover, the image sensing assembly can further include various components such as a carrying plate, a filter, a filter carrier, etc., but the present disclosure is not limited thereto.

When a coefficient of thermal expansion of the holder is α-holder, and a coefficient of thermal expansion of the retainer is α-retainer, the following condition is satisfied: α-retainer<α-holder. Therefore, it is favorable for securing the relative position of the lens barrel, the holder and the retainer, thereby maintaining optical quality. Please be noted that each of the holder and the retainer can have positive coefficient of thermal expansion (expanding with increasing temperature and contracting with decreasing temperature) or negative coefficient of thermal expansion (contracting with increasing temperature and expanding with decreasing temperature), or can have variable coefficient of thermal expansion with different expansion behaviors within different temperature ranges. Please be noted that unless otherwise specified, the coefficient of thermal expansion of one component in the present disclosure refers to a standard measurement value based on one atmosphere pressure at 25° C.

When a distance between the optical axis and a side of the first contacting surface close to the second contacting surface is D-1tocenter, and a distance between the optical axis and a side of the second contacting surface close to the first contacting surface is D-2tocenter, the following condition is satisfied: 0.05 mm≤|D-1tocenter−D-2tocenter|≤1.8 mm. Therefore, it is favorable for firmly securing the mechanism assembly within a certain extent. Moreover, the following condition can also be satisfied: 0.1 mm≤|D-1tocenter−D-2tocenter|≤1.8 mm. Moreover, the following condition can also be satisfied: 0.2 mm≤|D-1tocenter−D-2tocenter|≤1.8 mm.

When the distance between the optical axis and the side of the first contacting surface close to the second contacting surface is D-1tocenter, and the distance between the optical axis and the side of the second contacting surface close to the first contacting surface is D-2tocenter, the following condition can be satisfied: 0.01≤|D-1tocenter−D-2tocenter|/(D-1tocenter+D-2tocenter)≤0.145. Therefore, it is favorable for having a sufficient effort arm for moving the at least one lens element and the lens barrel.

When a coefficient of thermal expansion of the holder at 25° C. is α-holder25, and a coefficient of thermal expansion of the holder at 50° C. is α-holder50, the following condition can be satisfied: 1.01≤α-holder50/α-holder25≤3.63. Therefore, it is favorable for optimizing the thermal expansion within a specific ambient temperature range, thereby optimizing optical quality.

When the coefficient of thermal expansion of the holder is α-holder, and the coefficient of thermal expansion of the retainer is α-retainer, the following condition can be satisfied: 30 ppm/° C.<α-holder−α-retainer<240 ppm/° C. Therefore, it is favorable for securing the relative position of the lens barrel, the holder and the retainer, thereby maintaining optical quality.

When a coefficient of thermal expansion of the extension portion is α-extension, and a coefficient of thermal expansion of the retainer at 25° C. is α-retainer25, the following condition can be satisfied: 30 ppm/° C. s α-extension-α-retainer25≤240 ppm/° C.

When the coefficient of thermal expansion of the retainer is α-retainer, and a coefficient of thermal expansion of the arm is α-arm, the following condition can be satisfied: α-retainer≤α-arm. Therefore, it is favorable for further firmly securing the lens barrel to the holder in position.

When the coefficient of thermal expansion of the retainer is α-retainer, the coefficient of thermal expansion of the arm is α-arm, a coefficient of thermal expansion of the lens barrel is α-barrel, and the coefficient of thermal expansion of the holder is α-holder, the following condition can be satisfied: α-retainer<α-arm<α-barrel<α-holder. Therefore, it is favorable for securing the fixture relationship of the components.

When a coefficient of thermal expansion of the lens barrel at 25° C. is α-barrel25, and the coefficient of thermal expansion of the retainer at 25° C. is α-retainer25, the following condition can be satisfied: α-retainer25<α-barrel25.

When a thickness of the arm in parallel with the optical axis between the first contacting surface and the second contacting surface is T-arm, the following condition can be satisfied: 0.15 mm≤T-arm≤1.5 mm. Therefore, it is favorable for providing both bending flexibility and adequate support of the arm, thereby ensuring manufacturability. Moreover, the following condition can also be satisfied: 0.25 mm≤T-arm≤1.5 mm. Moreover, the following condition can also be satisfied: 0.25 mm≤T-arm≤1.2 mm. Moreover, the following condition can also be satisfied: 0.35 mm≤T-arm≤1.5 mm. Moreover, the following condition can also be satisfied: 0.35 mm≤T-arm≤1.2 mm. Moreover, the following condition can also be satisfied: 0.35 mm≤T-arm≤0.75 mm.

The arm can have a bending surface. The bending surface can be located closer to the optical axis than the first contacting surface and the second contacting surface. When a minimum thickness of the arm at the bending surface along a direction parallel to the optical axis is T-bend, and the thickness of the arm in parallel with the optical axis between the first contacting surface and the second contacting surface is T-arm, the following condition can be satisfied: 0.333≤T-bend/T-arm≤0.885. Therefore, it is favorable for controlling the deformation extent of the lens barrel caused by the bending of the arm, thereby maintaining optical quality. Moreover, a thickness of the arm along a direction parallel to the optical axis can gradually increase from a position where the bending surface is located towards a position where the first contacting surface is located. Moreover, the arm can further have a flat surface perpendicular to the optical axis and located closer to the optical axis than the bending surface. Moreover, a thickness of the arm at the flat surface along a direction parallel to the optical axis is greater than a thickness of the arm at the bending surface along a direction parallel to the optical axis.

When the minimum thickness of the arm at the bending surface along the direction parallel to the optical axis is T-bend, the following condition can be satisfied:

$$0.15 mm \leq T - bend \leq 1 mm .$$

When the thickness of the arm in parallel with the optical axis between the first contacting surface and the second contacting surface is T-arm, and a thickness of the lens barrel along a direction parallel to the optical axis is T-barrel, the following condition can be satisfied: 0.035≤T-arm/T-barrel≤0.18. Therefore, it is favorable for ensuring assembly stability.

The holder can further have a first recess surface. The first recess surface can face towards the arm. The first recess surface can be disposed adjacent to the first contacting surface and spaced apart from the arm. When a distance in parallel with the optical axis between the first recess surface and the arm is G-holder, the following condition can be satisfied: 0.01 mm≤G-holder≤0.4 mm. Therefore, it is favorable for preventing the risk of failure to return the component to its original position once the ambient temperature normalizes, thereby ensuring mechanism stability and mechanism reliability. Moreover, a gap formed between the first recess surface and the arm corresponds to the second contacting surface in a direction parallel to the optical axis. Moreover, the imaging lens can further include an insertion element. The insertion element can be disposed between the first recess surface and the arm, and the insertion element can be in contact with the first recess surface and the arm. Therefore, the insertion element is favorable for providing multiple functions such as buffering, elasticity, and sealing for optimizing the bending of the arm, thereby further ensuring mechanism stability and mechanism reliability.

The retainer can further have a second recess surface. The second recess surface can be disposed adjacent to the second contacting surface and spaced apart from the arm. When a distance in parallel with the optical axis between the second recess surface and the arm is G-retainer, the following condition can be satisfied: 0.01 mm≤G-retainer≤0.4 mm. Therefore, it is favorable for preventing the risk of failure to return the component to its original position once the ambient temperature normalizes, thereby ensuring mechanism stability and mechanism reliability.

The retainer can further have a mounting portion. The mounting portion can be fixed to the holder. Moreover, the retainer can be connected to the holder through the mounting portion. Moreover, the retainer can be mounted on the base of the holder through the mounting portion. Moreover, the third contacting surface can be located closer to the arm than the mounting portion. When the thickness of the arm in parallel with the optical axis between the first contacting surface and the second contacting surface is T-arm, and a length in parallel with the optical axis between the second contacting surface and the mounting portion is L-2tomount, the following condition can be satisfied: 0.042≤T-arm/L-2tomount≤0.775. Therefore, it is favorable for having sufficient deformation margin of the holder and the retainer along the optical axis, thereby ensuring the effectiveness of the temperature compensation mechanism.

When a length of the first contacting surface along a plane in parallel with the optical axis is L-holder, and a length of the second contacting surface along a plane in parallel with the optical axis is L-retainer, the following condition can be satisfied: 0.2<L-retainer/L-holder<5. Therefore, it is favorable for properly increasing the durability of the arm against an external force.

When a length of the surrounding inner surface along a direction parallel to the optical axis is L-toruinsidesurface, and a length of the bottom surface along a direction parallel to the optical axis is L-downsidesurface, the following condition can be satisfied: L-toruinsidesurface>L-downsidesurface.

In the imaging lens, the holder can further have an inner surface. The inner surface can face towards the optical axis. The inner surface and the lens barrel can form an air gap therebetween. The air gap is overlapped with the at least one lens element along a direction perpendicular to the optical axis. Therefore, it is favorable for having movement freedom of the lens element along the optical axis when subjected to force-induced deformation, thereby ensuring optical quality. Moreover, the air gap can be further formed between the arm and the holder.

In the imaging lens, the coefficient of thermal expansion (CTE) of each of the lens barrel, the holder and the retainer can be chosen from the values in the following Table 1 and Table 2 in which the definitions of α-barrel, α-holder25, α-holder and α-retainer are the same as the above statement and thus are not repeated.

TABLE 1

| | parameter | CTE (ppm/° C.) |
|---|---|---|
| lens barrel | α-barrel | 70 |
| holder | α-holder25 | 80 |
| | α-holder50 | 145 |
| retainer | α-retainer | 35 |

TABLE 2

| | parameter | CTE (ppm/° C.) |
|---|---|---|
| lens barrel | α-barrel | 70 |
| holder | α-holder | 80 |
| retainer | α-retainer | 25 |

In Table 1 and Table 2, each of the lens barrel, the holder and the retainer is made of plastic material. Moreover, the arm can have the same coefficient of thermal expansion as that of the lens barrel.

Please be noted that unless otherwise specified, the coefficient of thermal expansion of one component in the present disclosure refers to a standard measurement value at 25° C. In detail, the definition of α-barrel is generally equivalent to that of α-barrel25, the definition of α-holder is generally equivalent to that of α-holder25, the definition of α-retainer is generally equivalent to that of α-retainer25, the definition of α-arm is generally equivalent to the definition “a coefficient of thermal expansion of the arm at 25° C.” of α-arm25, and the definition of α-extension is generally equivalent to the definition “a coefficient of thermal expansion of the extension at 25° C.” of α-extension25.

According to the present disclosure, the aforementioned features and conditions can be utilized in numerous combinations so as to achieve corresponding effects.

According to the above description of the present disclosure, the following specific embodiments are provided for further explanation.

### 1st Embodiment

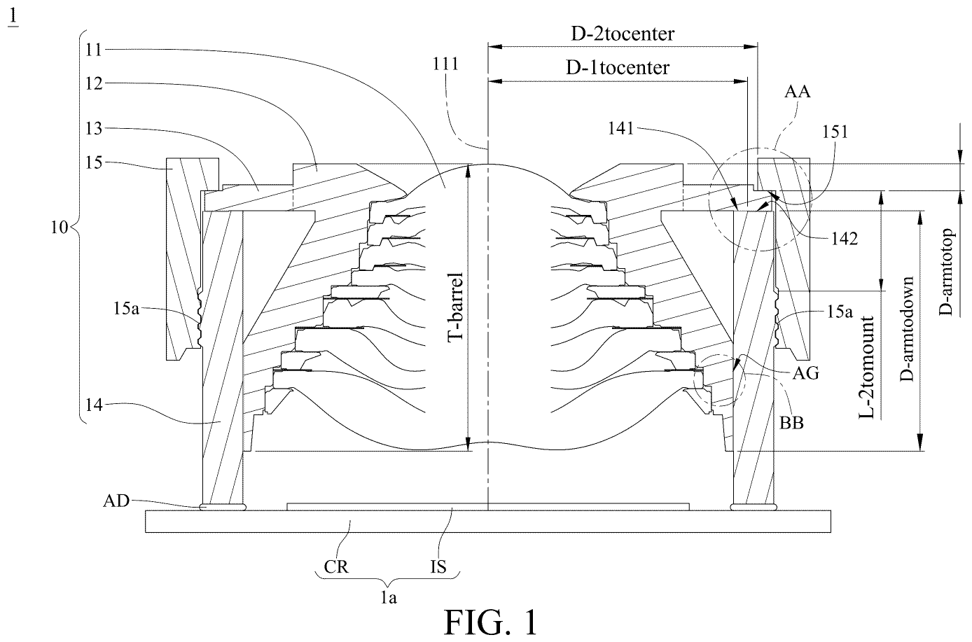

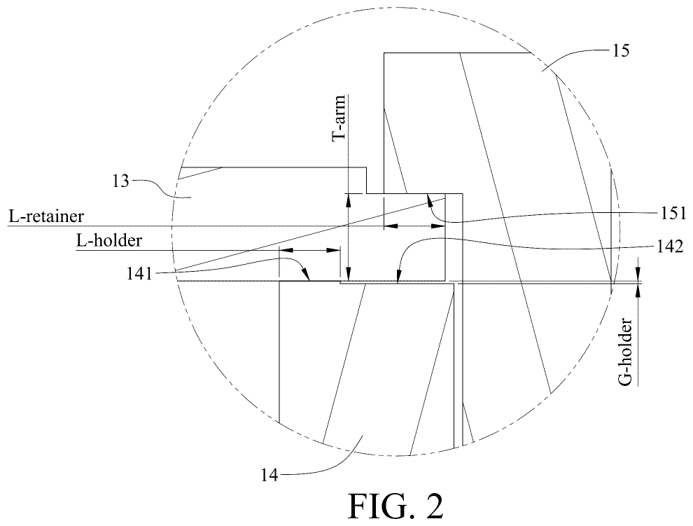

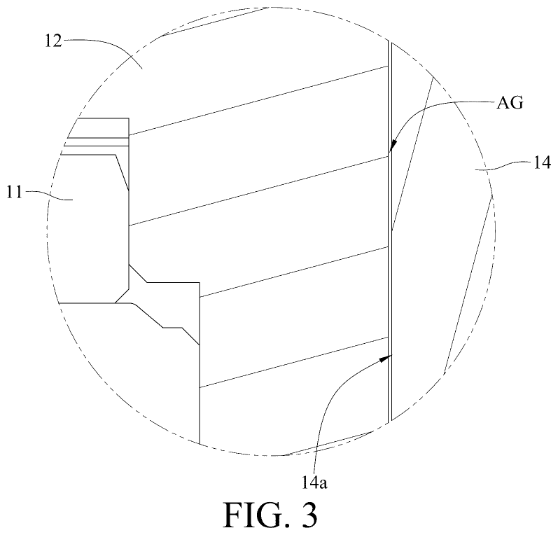

Please refer to FIG. 1 to FIG. 3, where FIG. 1 is a cross-sectional view of an imaging lens according to the 1st embodiment of the present disclosure, FIG. 2 is an enlarged view of AA region of the imaging lens of FIG. 1, and FIG. 3 is an enlarged view of BB region of the imaging lens of FIG. 1.

A camera module 1 provided in this embodiment includes an imaging lens 10 and an image sensing assembly 1a.

The imaging lens 10 includes a plurality of lens elements 11, a lens barrel 12, an arm 13, a holder 14 and a retainer 15. The lens elements 11 form a lens assembly (not numbered).

The lens elements 11 have an optical axis 111. The lens elements 11 are arranged along the optical axis 111. The lens barrel 12 accommodates (or carries) the lens elements 11. Please note that the quantity and the shapes of the lens elements 11 shown in the drawings are exemplary only, and some contours thereof are omitted to prevent obscuring the present disclosure. The present disclosure is not limited to the quantity and the shapes of the lens elements 11 in the drawings.

The arm 13 is disposed on a side of the lens barrel 12 away from the optical axis 111. The arm 13 extends from the lens barrel 12 along a direction away from the optical axis 111. In this embodiment, the arm 13 is integrally formed with the lens barrel 12, and the boundary between the arm 13 and the lens barrel 12 is shown by dash lines in FIG. 1 for distinguishing the arm 13 from the lens barrel 12. In this embodiment, a distance between the arm 13 and an object end of the lens barrel 12 is less than a distance between the arm 13 and an image end of the lens barrel 12.

The holder 14 has a first contacting surface 141 overlapped with and in contact with the arm 13 in a direction parallel to the optical axis 111.

The retainer 15 is fixed on the holder 14 through structural mounting. The retainer 15 has a second contacting surface 151 overlapped with and in contact with the arm 13 in a direction parallel to the optical axis 111. The second contacting surface 151 is located on an opposite side of the first contacting surface 141. The retainer 15 abuts on the arm 13 through the second contacting surface 151 to keep the arm 13 in constant contact with the first contacting surface 141.

In the imaging lens 10, the arm 13 is disposed between the holder 14 and the retainer 15, and the holder 14 and the retainer 15 are made of different materials. The first contacting surface 141 and the second contacting surface 151 surround the optical axis 111 and are non-overlapped with each other in a direction parallel to the optical axis 111.

The image sensing assembly 1a includes a carrying plate CR and an image sensor IS. The carrying plate CR is fixed on the holder 14 through adhesive dispensing via adhesive AD. The image sensor IS is disposed on the carrying plate CR and is located on an image side of the imaging lens 10.

When a coefficient of thermal expansion of the lens barrel 12 is α-barrel, a coefficient of thermal expansion of the arm 13 is α-arm, a coefficient of thermal expansion of the holder 14 is α-holder, a coefficient of thermal expansion of the holder 14 at 25° C. is α-holder25, a coefficient of thermal expansion of the holder 14 at 50° C. is α-holder50, and a coefficient of thermal expansion of the retainer 15 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 12 at 25° C. is α-barrel25, and a coefficient of thermal expansion of the retainer 15 at 25° C. is α-retainer25, the following condition is satisfied: α-retainer25<α-barrel25.

When a distance between the optical axis 111 and a side of the first contacting surface 141 close to the second contacting surface 151 is D-1tocenter, and a distance between the optical axis 111 and a side of the second contacting surface 151 close to the first contacting surface 141 is D-2tocenter, the following conditions are satisfied: D-1tocenter=6.45 mm; D-2tocenter=6.7 mm; |D-1tocenter− D-2tocenter|=0.25 mm; and |D-1tocenter−D-2tocenter|/(D-1tocenter+D-2tocenter)=0.019.

When the distance between the arm 13 and the object end of the lens barrel 12 is D-armtotop, and the distance between the arm 13 and the image end of the lens barrel 12 is D-armtodown, the following conditions are satisfied: D-armtotop=0.67 mm; D-armtodown=5.98 mm; and D-armtotop<D-armtodown.

When a thickness of the lens barrel 12 along a direction parallel to the optical axis 111 is T-barrel, and a thickness of the arm 13 in parallel with the optical axis 111 between the first contacting surface 141 and the second contacting surface 151 is T-arm, the following conditions are satisfied: T-barrel=7.15 mm; T-arm=0.5 mm; and T-arm/T-barrel=0.0699.

The holder 14 further has a first recess surface 142 facing towards the arm 13. The first recess surface 142 is disposed adjacent to the first contacting surface 141 and spaced apart from the arm 13. When a distance in parallel with the optical axis 111 between the first recess surface 142 and the arm 13 is G-holder, the following condition is satisfied: G-holder=0.015 mm. A gap formed between the first recess surface 142 and the arm 13 corresponds to the second contacting surface 151 in a direction parallel to the optical axis 111.

The retainer 15 further has a mounting portion 15a fixed to the holder 14, and the retainer 15 is connected to the holder 14 through the mounting portion 15a. The mounting portion 15a and the holder 14 have matching convex-concave shapes at their respective fixed positions. When the thickness of the arm 13 in parallel with the optical axis 111 between the first contacting surface 141 and the second contacting surface 151 is T-arm, and a length in parallel with the optical axis 111 between the second contacting surface 151 and the mounting portion 15a is L-2tomount, the following conditions are satisfied: T-arm=0.5 mm; L-2tomount=2.5 mm; and T-arm/L-2tomount=0.2.

When a length of the first contacting surface 141 along a plane in parallel with the optical axis 111 is L-holder, and a length of the second contacting surface 151 along a plane in parallel with the optical axis is L-retainer, the following conditions are satisfied: L-holder=0.35 mm; L-retainer=0.35 mm; and L-retainer/L-holder=1.

The holder 14 further has an inner surface 14a facing towards the optical axis 111. The inner surface 14a and the lens barrel 12 form an air gap AG therebetween. The air gap AG is overlapped with the lens elements 11 along a direction perpendicular to the optical axis 111.

### 2nd Embodiment

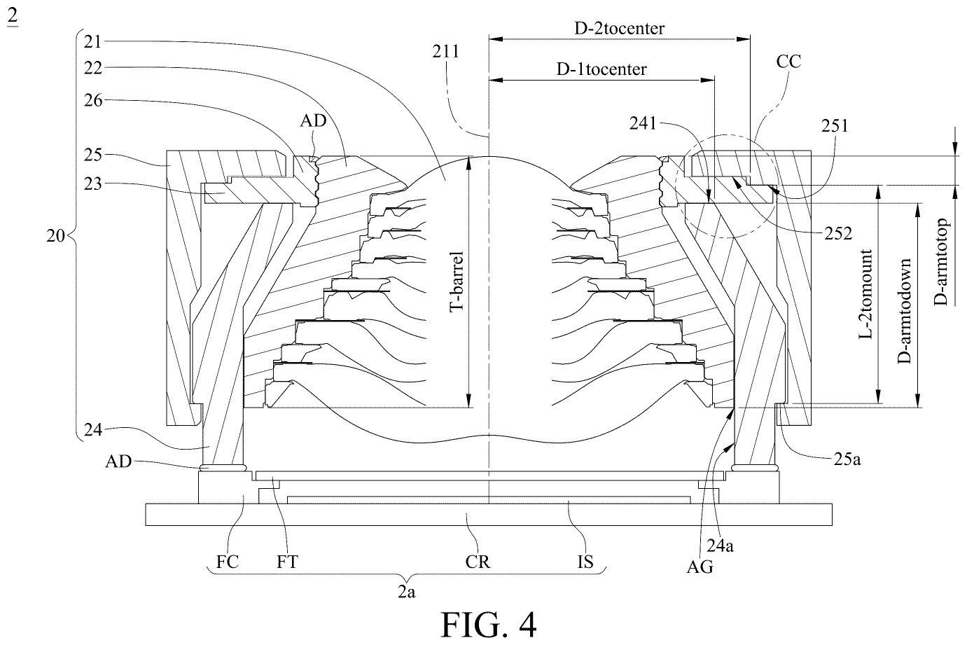

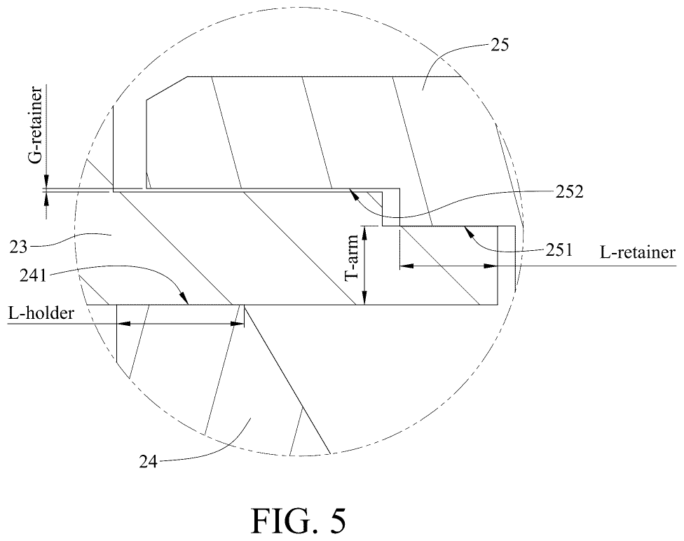

Please refer to FIG. 4 to FIG. 5, where FIG. 4 is a cross-sectional view of an imaging lens according to the 2nd embodiment of the present disclosure, and FIG. 5 is an enlarged view of CC region of the imaging lens of FIG. 4.

A camera module 2 provided in this embodiment includes an imaging lens 20 and an image sensing assembly 2a.

The imaging lens 20 includes a plurality of lens elements 21, a lens barrel 22, an arm 23, a holder 24, a retainer 25 and a connector 26. The lens elements 21 form a lens assembly (not numbered).

The lens elements 21 have an optical axis 211. The lens elements 21 are arranged along the optical axis 211. The lens barrel 22 accommodates (or carries) the lens elements 21. Please note that the quantity and the shapes of the lens elements 21 shown in the drawings are exemplary only, and some contours thereof are omitted to prevent obscuring the present disclosure. The present disclosure is not limited to the quantity and the shapes of the lens elements 21 in the drawings.

The arm 23 is disposed on a side of the lens barrel 22 away from the optical axis 211. The arm 23 extends from the lens barrel 22 along a direction away from the optical axis 211. In this embodiment, the arm 23 is disposed on the lens barrel 22 through structural mounting via the connector 26 formed on the arm 23. The connector 26 and lens barrel 22 have matching convex-concave shapes at their respective fixed positions, with adhesive AD dispensing on an object side of their fixed positions to secure the connection relationship between the connector 26 and the lens barrel 22. In this embodiment, a distance between the arm 23 and an object end of the lens barrel 22 is less than a distance between the arm 23 and an image end of the lens barrel 22.

The holder 24 has a first contacting surface 241 overlapped with and in contact with the arm 23 in a direction parallel to the optical axis 211.

The retainer 25 is fixed on the holder 24 through structural mounting. The retainer 25 has a second contacting surface 251 overlapped with and in contact with the arm 23 in a direction parallel to the optical axis 211. The second contacting surface 251 is located on an opposite side of the first contacting surface 241. The retainer 25 abuts on the arm 23 through the second contacting surface 251 to keep the arm 23 in constant contact with the first contacting surface 241.

In the imaging lens 20, the arm 23 is disposed between the holder 24 and the retainer 25, and the holder 24 and the retainer 25 are made of different materials. The first contacting surface 241 and the second contacting surface 251 surround the optical axis 211 and are non-overlapped with each other in a direction parallel to the optical axis 211.

The image sensing assembly 2a includes a carrying plate CR, an image sensor IS, a filter carrier FC and a filter FT The image sensor IS is disposed on the carrying plate CR and is located on an image side of the imaging lens 20. The filter carrier FC is disposed on the carrying plate CR and is fixed on the holder 24 through adhesive dispensing via adhesive AD. The filter FT is disposed on the filter carrier FC and is located on an object side of the image sensor IS.

When a coefficient of thermal expansion of the lens barrel 22 is α-barrel, a coefficient of thermal expansion of the arm 23 is α-arm, a coefficient of thermal expansion of the holder 24 is α-holder, a coefficient of thermal expansion of the holder 24 at 25° C. is α-holder25, a coefficient of thermal expansion of the holder 24 at 50° C. is α-holder50, and a coefficient of thermal expansion of the retainer 25 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 22 at 25° C. is α-barrel25, and a coefficient of thermal expansion of the retainer 25 at 25° C. is α-retainer25, the following condition is satisfied: α-retainer25<α-barrel25.

When a distance between the optical axis 211 and a side of the first contacting surface 241 close to the second contacting surface 251 is D-1tocenter, and a distance between the optical axis 211 and a side of the second contacting surface 251 close to the first contacting surface 241 is D-2tocenter, the following conditions are satisfied: D-1tocenter=5.6 mm; D-2tocenter=6.489 mm; |D-1tocenter− D-2tocenter|=0.889 mm; and |D-1tocenter−D-2tocenter|/(D-1tocenter+D-2tocenter)=0.0735.

When the distance between the arm 23 and the object end of the lens barrel 22 is D-armtotop, and the distance between the arm 23 and the image end of the lens barrel 22 is D-armtodown, the following conditions are satisfied: D-armtotop=0.67 mm; D-armtodown=5.98 mm; and D-armtotop<D-armtodown.

When a thickness of the lens barrel 22 along a direction parallel to the optical axis 211 is T-barrel, and a thickness of the arm 23 in parallel with the optical axis 211 between the first contacting surface 241 and the second contacting surface 251 is T-arm, the following conditions are satisfied: T-barrel=6.245 mm; T-arm=0.45 mm; and T-arm/T-barrel=0.0721.

The retainer 25 further has a second recess surface 252 disposed adjacent to the second contacting surface 251 and spaced apart from the arm 23. When a distance in parallel with the optical axis 211 between the second recess surface 252 and the arm 23 is G-retainer, the following condition is satisfied: G-retainer=0.02 mm.

The retainer 25 further has a mounting portion 25a fixed to the holder 24, and the retainer 25 is connected to the holder 24 through the mounting portion 25a. The mounting portion 25a and the holder 24 have matching snap-fit structures at their respective fixed positions. When the thickness of the arm 23 in parallel with the optical axis 211 between the first contacting surface 241 and the second contacting surface 251 is T-arm, and a length in parallel with the optical axis 211 between the second contacting surface 251 and the mounting portion 25a is L-2tomount, the following conditions are satisfied: T-arm=0.45 mm; L-2tomount=5.42 mm; and T-arm/L-2tomount=0.083.

When a length of the first contacting surface 241 along a plane in parallel with the optical axis 211 is L-holder, and a length of the second contacting surface 251 along a plane in parallel with the optical axis is L-retainer, the following conditions are satisfied: L-holder=0.73 mm; L-retainer=0.56 mm; and L-retainer/L-holder=0.767.

The holder 24 further has an inner surface 24a facing towards the optical axis 211. The inner surface 24a and the lens barrel 22 form an air gap AG therebetween.

The air gap AG is overlapped with the lens elements 21 along a direction perpendicular to the optical axis 211.

### 3rd Embodiment

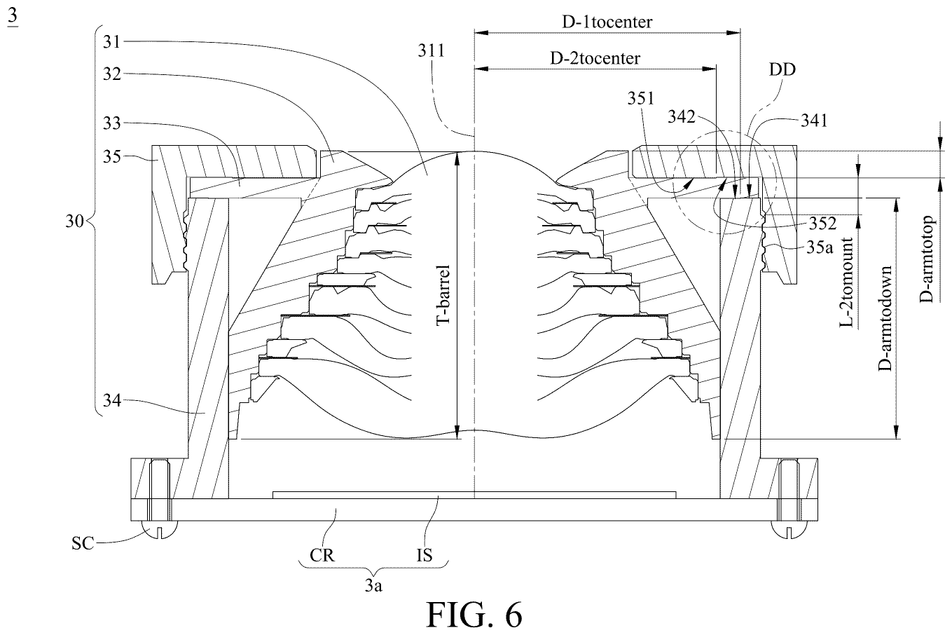

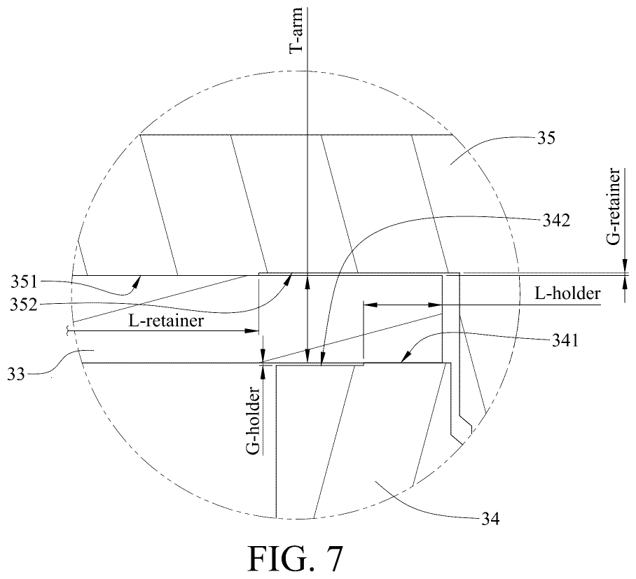

Please refer to FIG. 6 to FIG. 7, where FIG. 6 is a cross-sectional view of an imaging lens according to the 3rd embodiment of the present disclosure, and FIG. 7 is an enlarged view of DD region of the imaging lens of FIG. 6.

A camera module 3 provided in this embodiment includes an imaging lens 30 and an image sensing assembly 3a.

The imaging lens 30 includes a plurality of lens elements 31, a lens barrel 32, an arm 33, a holder 34 and a retainer 35. The lens elements 31 form a lens assembly (not numbered).

The lens elements 31 have an optical axis 311. The lens elements 31 are arranged along the optical axis 311. The lens barrel 32 accommodates (or carries) the lens elements 31. Please note that the quantity and the shapes of the lens elements 31 shown in the drawings are exemplary only, and some contours thereof are omitted to prevent obscuring the present disclosure. The present disclosure is not limited to the quantity and the shapes of the lens elements 31 in the drawings.

The arm 33 is disposed on a side of the lens barrel 32 away from the optical axis 311. The arm 33 extends from the lens barrel 32 along a direction away from the optical axis 311. In this embodiment, the arm 33 is integrally formed with the lens barrel 32, and the boundary between the arm 33 and the lens barrel 32 is shown by dash lines in FIG. 6 for distinguishing the arm 33 from the lens barrel 32. In this embodiment, a distance between the arm 33 and an object end of the lens barrel 32 is less than a distance between the arm 33 and an image end of the lens barrel 32.

The holder 34 is configured for the lens barrel 32 to be disposed thereon so as to correspond the lens barrel 32 to the image sensing assembly 3a. The holder 34 has a first contacting surface 341 overlapped with and in contact with the arm 33 in a direction parallel to the optical axis 311.

The retainer 35 is fixed on the holder 34 through structural mounting. The retainer 35 has a second contacting surface 351 overlapped with and in contact with the arm 33 in a direction parallel to the optical axis 311. The second contacting surface 351 is located on an opposite side of the first contacting surface 341. The retainer 35 abuts on the arm 33 through the second contacting surface 351 to keep the arm 33 in constant contact with the first contacting surface 341.

In the imaging lens 30, the arm 33 is disposed between the holder 34 and the retainer 35, and the holder 34 and the retainer 35 are made of different materials.

The first contacting surface 341 and the second contacting surface 351 surround the optical axis 311 and are non-overlapped with each other in a direction parallel to the optical axis 311.

The image sensing assembly 3a includes a carrying plate CR and an image sensor IS. The carrying plate CR is fixed on the holder 34 through screwing via screws SC. The image sensor IS is disposed on the carrying plate CR and is located on an image side of the imaging lens 30.

When a coefficient of thermal expansion of the lens barrel 32 is α-barrel, a coefficient of thermal expansion of the arm 33 is α-arm, a coefficient of thermal expansion of the holder 34 is α-holder, a coefficient of thermal expansion of the holder 34 at 25° C. is α-holder25, a coefficient of thermal expansion of the holder 34 at 50° C. is α-holder50, and a coefficient of thermal expansion of the retainer 35 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 32 at 25° C. is α-barrel25, and a coefficient of thermal expansion of the retainer 35 at 25° C. is α-retainer25, the following condition is satisfied: α-retainer25<α-barrel25.

When a distance between the optical axis 311 and a side of the first contacting surface 341 close to the second contacting surface 351 is D-1tocenter, and a distance between the optical axis 311 and a side of the second contacting surface 351 close to the first contacting surface 341 is D-2tocenter, the following conditions are satisfied: D-1tocenter=6.6 mm; D-2tocenter=6 mm; |D-1tocenter−D-2tocenter|=0.6 mm; and |D-1tocenter−D-2tocenter|/(D-1tocenter+D-2tocenter)=0.0476.

When the distance between the arm 33 and the object end of the lens barrel 32 is D-armtotop, and the distance between the arm 33 and the image end of the lens barrel 32 is D-armtodown, the following conditions are satisfied: D-armtotop=0.67 mm; D-armtodown=5.98 mm; and D-armtotop<D-armtodown.

When a thickness of the lens barrel 32 along a direction parallel to the optical axis 311 is T-barrel, and a thickness of the arm 33 in parallel with the optical axis 311 between the first contacting surface 341 and the second contacting surface 351 is T-arm, the following conditions are satisfied: T-barrel=7.15 mm; T-arm=0.5 mm; and T-arm/T-barrel=0.0699.

The holder 34 further has a first recess surface 342 facing towards the arm 33. The first recess surface 342 is disposed adjacent to the first contacting surface 341 and spaced apart from the arm 33. When a distance in parallel with the optical axis 311 between the first recess surface 342 and the arm 33 is G-holder, the following condition is satisfied: G-holder=0.015 mm.

The retainer 35 further has a second recess surface 352 disposed adjacent to the second contacting surface 351 and spaced apart from the arm 33. When a distance in parallel with the optical axis 311 between the second recess surface 352 and the arm 33 is G-retainer, the following condition is satisfied: G-retainer=0.015 mm.

The retainer 35 further has a mounting portion 35a fixed to the holder 34, and the retainer 35 is connected to the holder 34 through the mounting portion 35a. The mounting portion 35a and the holder 34 have matching convex-concave shapes at their respective fixed positions. When the thickness of the arm 33 in parallel with the optical axis 311 between the first contacting surface 341 and the second contacting surface 351 is T-arm, and a length in parallel with the optical axis 311 between the second contacting surface 351 and the mounting portion 35a is L-2tomount, the following conditions are satisfied: T-arm=0.5 mm; L-2tomount=0.91 mm; and T-arm/L-2tomount=0.549.

When a length of the first contacting surface 341 along a plane in parallel with the optical axis 311 is L-holder, and a length of the second contacting surface 351 along a plane in parallel with the optical axis is L-retainer, the following conditions are satisfied: L-holder=0.45 mm; L-retainer=2 mm; and L-retainer/L-holder=4.44.

### 4th Embodiment

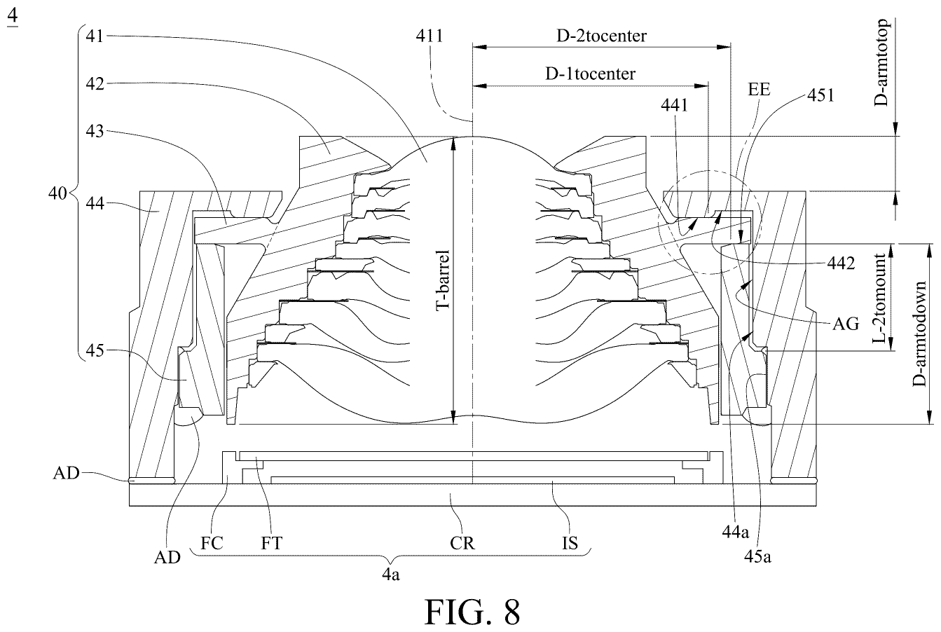

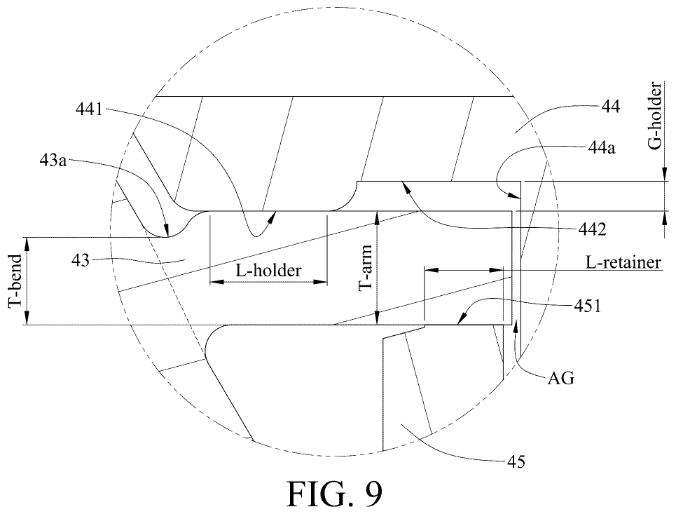

Please refer to FIG. 8 to FIG. 9, where FIG. 8 is a cross-sectional view of an imaging lens according to the 4th embodiment of the present disclosure, and FIG. 9 is an enlarged view of EE region of the imaging lens of FIG. 8.

A camera module 4 provided in this embodiment includes an imaging lens 40 and an image sensing assembly 4a.

The imaging lens 40 includes a plurality of lens elements 41, a lens barrel 42, an arm 43, a holder 44 and a retainer 45. The lens elements 41 form a lens assembly (not numbered).

The lens elements 41 have an optical axis 411. The lens elements 41 are arranged along the optical axis 411. The lens barrel 42 accommodates (or carries) the lens elements 41. Please note that the quantity and the shapes of the lens elements 41 shown in the drawings are exemplary only, and some contours thereof are omitted to prevent obscuring the present disclosure. The present disclosure is not limited to the quantity and the shapes of the lens elements 41 in the drawings.

The arm 43 is disposed on a side of the lens barrel 42 away from the optical axis 411. The arm 43 extends from the lens barrel 42 along a direction away from the optical axis 411. In this embodiment, the arm 43 is integrally formed with the lens barrel 42, and the boundary between the arm 43 and the lens barrel 42 is shown by dash lines in FIG. 8 for distinguishing the arm 43 from the lens barrel 42. In this embodiment, a distance between the arm 43 and an object end of the lens barrel 42 is less than a distance between the arm 43 and an image end of the lens barrel 42.

The holder 44 has a first contacting surface 441 overlapped with and in contact with the arm 43 in a direction parallel to the optical axis 411.

The retainer 45 is fixed on the holder 44 through structural mounting, with adhesive AD applied therebetween to secure the fixed relationship thereof. The retainer 45 has a second contacting surface 451 overlapped with and in contact with the arm 43 in a direction parallel to the optical axis 411. The second contacting surface 451 is located on an opposite side of the first contacting surface 441. The retainer 45 abuts on the arm 43 through the second contacting surface 451 to keep the arm 43 in constant contact with the first contacting surface 441.

In the imaging lens 40, the arm 43 is disposed between the holder 44 and the retainer 45, and the holder 44 and the retainer 45 are made of different materials. The first contacting surface 441 and the second contacting surface 451 surround the optical axis 411 and are non-overlapped with each other in a direction parallel to the optical axis 411.

The image sensing assembly 4a includes a carrying plate CR, an image sensor IS, a filter carrier FC and a filter FT. The carrying plate CR is fixed on the holder 44 through adhesive dispensing via adhesive AD. The image sensor IS is disposed on the carrying plate CR and is located on an image side of the imaging lens 40. The filter carrier FC is disposed on the carrying plate CR. The filter FT is disposed on the filter carrier FC and is located on an object side of the image sensor IS.

When a coefficient of thermal expansion of the lens barrel 42 is α-barrel, a coefficient of thermal expansion of the arm 43 is α-arm, a coefficient of thermal expansion of the holder 44 is α-holder, a coefficient of thermal expansion of the holder 44 at 25° C. is α-holder25, a coefficient of thermal expansion of the holder 44 at 50° C. is α-holder50, and a coefficient of thermal expansion of the retainer 45 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 42 at 25° C. is α-barrel25, and a coefficient of thermal expansion of the retainer 45 at 25° C. is α-retainer25, the following condition is satisfied: α-retainer25<α-barrel25.

When a distance between the optical axis 411 and a side of the first contacting surface 441 close to the second contacting surface 451 is D-1tocenter, and a distance between the optical axis 411 and a side of the second contacting surface 451 close to the first contacting surface 441 is D-2tocenter, the following conditions are satisfied: D-1tocenter=5.84 mm; D-2tocenter=6.4 mm; |D-1tocenter− D-2tocenter|=0.56 mm; and |D-1tocenter−D-2tocenter|/(D-1tocenter+D-2tocenter)=0.0458.

When the distance between the arm 43 and the object end of the lens barrel 42 is D-armtotop, and the distance between the arm 43 and the image end of the lens barrel 42 is D-armtodown, the following conditions are satisfied: D-armtotop=0.67 mm; D-armtodown=5.98 mm; and D-armtotop<D-armtodown.

When a thickness of the lens barrel 42 along a direction parallel to the optical axis 411 is T-barrel, and a thickness of the arm 43 in parallel with the optical axis 411 between the first contacting surface 441 and the second contacting surface 451 is T-arm, the following conditions are satisfied: T-barrel=7.15 mm; T-arm=0.65 mm; and T-arm/T-barrel=0.0910.

The arm 43 has a bending surface 43a located closer to the optical axis 411 than the first contacting surface 441 and the second contacting surface 451. When a minimum thickness of the arm 43 at the bending surface 43a along a direction parallel to the optical axis 411 is T-bend, and the thickness of the arm 43 in parallel with the optical axis 411 between the first contacting surface 441 and the second contacting surface 451 is T-arm, the following conditions are satisfied: T-bend=0.5 mm; T-arm=0.65 mm; and T-bend/T-arm=0.769. A thickness of the arm 43 along a direction parallel to the optical axis 411 gradually increases from a position where the bending surface 43a is located towards a position where the first contacting surface 441 is located.

The holder 44 further has a first recess surface 442 facing towards the arm 43. The first recess surface 442 is disposed adjacent to the first contacting surface 441 and spaced apart from the arm 43. When a distance in parallel with the optical axis 411 between the first recess surface 442 and the arm 43 is G-holder, the following condition is satisfied: G-holder=0.017 mm. A gap formed between the first recess surface 442 and the arm 43 corresponds to the second contacting surface 451 in a direction parallel to the optical axis 411.

The retainer 45 further has a mounting portion 45a fixed to the holder 44, and the retainer 45 is connected to the holder 44 through the mounting portion 45a. The mounting portion 45a and the holder 44 have matching snap-fit structures at their respective fixed positions. When the thickness of the arm 43 in parallel with the optical axis 411 between the first contacting surface 441 and the second contacting surface 451 is T-arm, and a length in parallel with the optical axis 411 between the second contacting surface 451 and the mounting portion 45a is L-2tomount, the following conditions are satisfied: T-arm=0.65 mm; L-2tomount=2.66 mm; and T-arm/L-2tomount=0.244.

When a length of the first contacting surface 441 along a plane in parallel with the optical axis 411 is L-holder, and a length of the second contacting surface 451 along a plane in parallel with the optical axis is L-retainer, the following conditions are satisfied: L-holder=0.67 mm; L-retainer=0.45 mm; and L-retainer/L-holder=0.672.

The holder 44 further has an inner surface 44a facing towards the optical axis 411. The inner surface 44a and the lens barrel 42 form an air gap AG therebetween.

The air gap AG is overlapped with the lens elements 41 along a direction perpendicular to the optical axis 411. The air gap AG is also formed between the arm 43 and the holder 44.

### 5th Embodiment

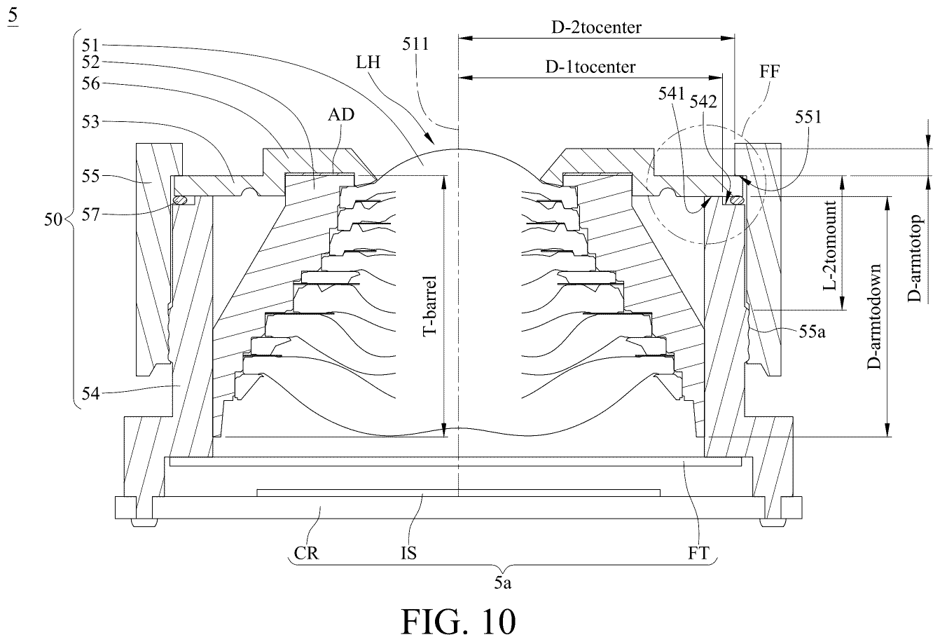

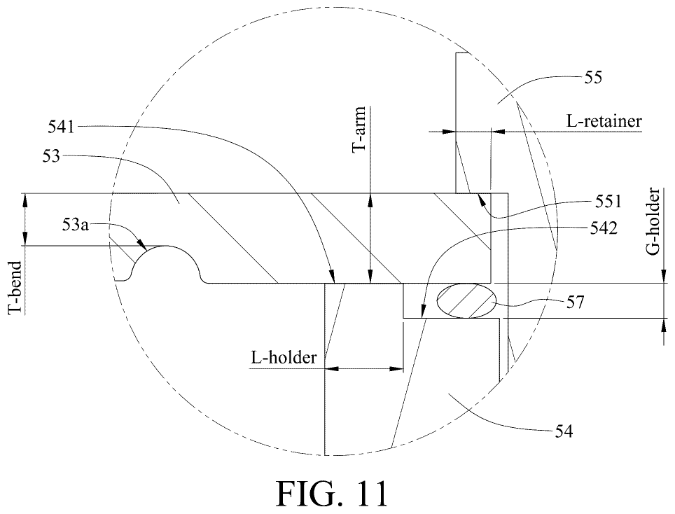

Please refer to FIG. 10 to FIG. 11, where FIG. 10 is a cross-sectional view of an imaging lens according to the 5th embodiment of the present disclosure, and FIG. 11 is an enlarged view of FF region of the imaging lens of FIG. 10.

A camera module 5 provided in this embodiment includes an imaging lens 50 and an image sensing assembly Sa.

The imaging lens 50 includes a plurality of lens elements 51, a lens barrel 52, an arm 53, a holder 54, a retainer 55 and a connector 56. The lens elements 51 form a lens assembly (not numbered).

The lens elements 51 have an optical axis 511. The lens elements 51 are arranged along the optical axis 511. The lens barrel 52 accommodates (or carries) the lens elements 51. Please note that the quantity and the shapes of the lens elements 51 shown in the drawings are exemplary only, and some contours thereof are omitted to prevent obscuring the present disclosure. The present disclosure is not limited to the quantity and the shapes of the lens elements 51 in the drawings.

The arm 53 is disposed on a side of the lens barrel 52 away from the optical axis 511. The arm 53 extends from the lens barrel 52 along a direction away from the optical axis 511. In this embodiment, the arm 53 is disposed on the lens barrel 52 through adhesive dispensing via adhesive AD applied on the connector 56 that is formed on the arm 53. In this embodiment, a distance between the arm 53 and an object end of the lens barrel 52 is less than a distance between the arm 53 and an image end of the lens barrel 52.

The holder 54 is configured for the lens barrel 52 to be disposed thereon so as to correspond the lens barrel 52 to the image sensing assembly Sa. The holder 54 has a first contacting surface 541 overlapped with and in contact with the arm 53 in a direction parallel to the optical axis 511.

The retainer 55 is fixed on the holder 54 through structural mounting. The retainer 55 has a second contacting surface 551 overlapped with and in contact with the arm 53 in a direction parallel to the optical axis 511. The second contacting surface 551 is located on an opposite side of the first contacting surface 541. The retainer 55 abuts on the arm 53 through the second contacting surface 551 to keep the arm 53 in constant contact with the first contacting surface 541.

The connector 56 surrounds the optical axis 511 and forms a light-passable hole LH located at a position where the aperture of the imaging lens 50 is located.

In the imaging lens 50, the arm 53 is disposed between the holder 54 and the retainer 55, and the holder 54 and the retainer 55 are made of different materials. The first contacting surface 541 and the second contacting surface 551 surround the optical axis 511 and are non-overlapped with each other in a direction parallel to the optical axis 511.

The image sensing assembly 5a includes a carrying plate CR, an image sensor IS and a filter FT. The holder 54 is disposed through the carrying plate CR. The image sensor IS is disposed on the carrying plate CR and is located on an image side of the imaging lens 50. The filter FT is located on an object side of the image sensor IS.

When a coefficient of thermal expansion of the lens barrel 52 is α-barrel, a coefficient of thermal expansion of the arm 53 is α-arm, a coefficient of thermal expansion of the holder 54 is α-holder, a coefficient of thermal expansion of the holder 54 at 25° C. is α-holder25, a coefficient of thermal expansion of the holder 54 at 50° C. is α-holder50, and a coefficient of thermal expansion of the retainer 55 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 52 at 25° C. is α-barrel25, and a coefficient of thermal expansion of the retainer 55 at 25° C. is α-retainer25, the following condition is satisfied: α-retainer25<α-barrel25.

When a distance between the optical axis 511 and a side of the first contacting surface 541 close to the second contacting surface 551 is D-1tocenter, and a distance between the optical axis 511 and a side of the second contacting surface 551 close to the first contacting surface 541 is D-2tocenter, the following conditions are satisfied: D-1tocenter=6.55 mm; D-2tocenter=6.85 mm; |D-1tocenter− D-2tocenter|=0.3 mm; and |D-1tocenter−D-2tocenter|/(D-1tocenter+D-2tocenter)=0.0224.

When the distance between the arm 53 and the object end of the lens barrel 52 is D-armtotop, and the distance between the arm 53 and the image end of the lens barrel 52 is D-armtodown, the following conditions are satisfied: D-armtotop=0.67 mm; D-armtodown=5.965 mm; and D-armtotop<D-armtodown.

When a thickness of the lens barrel 52 along a direction parallel to the optical axis 511 is T-barrel, and a thickness of the arm 53 in parallel with the optical axis 511 between the first contacting surface 541 and the second contacting surface 551 is T-arm, the following conditions are satisfied: T-barrel=6.49 mm; T-arm=0.515 mm; and T-arm/T-barrel=0.0794.

The arm 53 has a bending surface 53a located closer to the optical axis 511 than the first contacting surface 541 and the second contacting surface 551. When a minimum thickness of the arm 53 at the bending surface 53a along a direction parallel to the optical axis 511 is T-bend, and the thickness of the arm 53 in parallel with the optical axis 511 between the first contacting surface 541 and the second contacting surface 551 is T-arm, the following conditions are satisfied: T-bend=0.3 mm; T-arm=0.515 mm; and T-bend/T-arm=0.583. A thickness of the arm 53 along a direction parallel to the optical axis 511 gradually increases from a position where the bending surface 53a is located towards a position where the first contacting surface 541 is located.

The holder 54 further has a first recess surface 542 facing towards the arm 53. The first recess surface 542 is disposed adjacent to the first contacting surface 541 and spaced apart from the arm 53. When a distance in parallel with the optical axis 511 between the first recess surface 542 and the arm 53 is G-holder, the following condition is satisfied: G-holder=0.2 mm. A gap formed between the first recess surface 542 and the arm 53 corresponds to the second contacting surface 551 in a direction parallel to the optical axis 511. The imaging lens 50 further includes an insertion element 57 disposed between the first recess surface 542 and the arm 53, and the insertion element 57 is in contact with the first recess surface 542 and the arm 53.

The retainer 55 further has a mounting portion 55a fixed to the holder 54, and the retainer 55 is connected to the holder 54 through the mounting portion 55a. The mounting portion 55a and the holder 54 have matching convex-concave shapes at their respective fixed positions. When the thickness of the arm 53 in parallel with the optical axis 511 between the first contacting surface 541 and the second contacting surface 551 is T-arm, and a length in parallel with the optical axis 511 between the second contacting surface 551 and the mounting portion 55a is L-2tomount, the following conditions are satisfied: T-arm=0.515 mm; L-2tomount=3.33 mm; and T-arm/L-2tomount=0.155.

When a length of the first contacting surface 541 along a plane in parallel with the optical axis 511 is L-holder, and a length of the second contacting surface 551 along a plane in parallel with the optical axis is L-retainer, the following conditions are satisfied: L-holder=0.45 mm; L-retainer=0.2 mm; and L-retainer/L-holder=0.444.

### 6th Embodiment

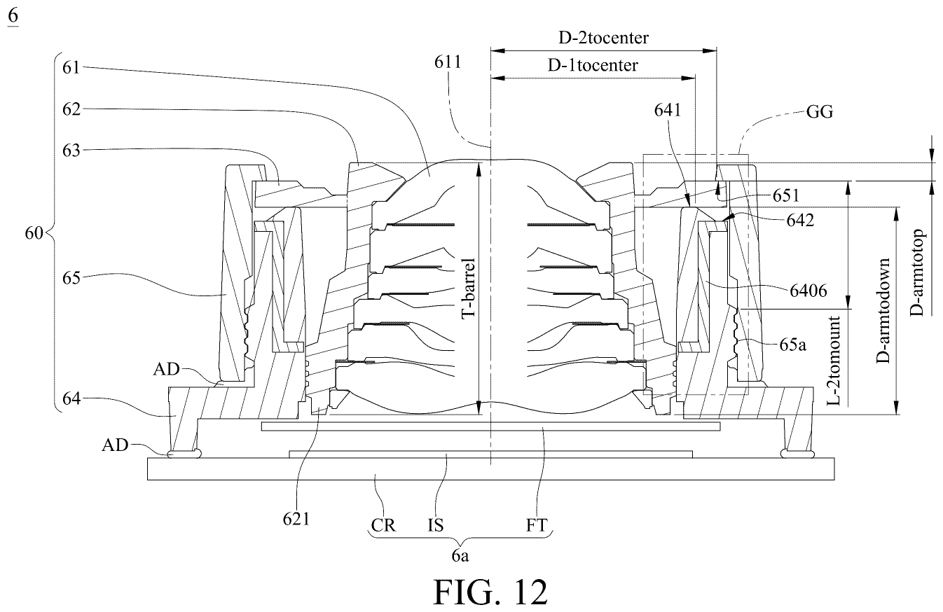

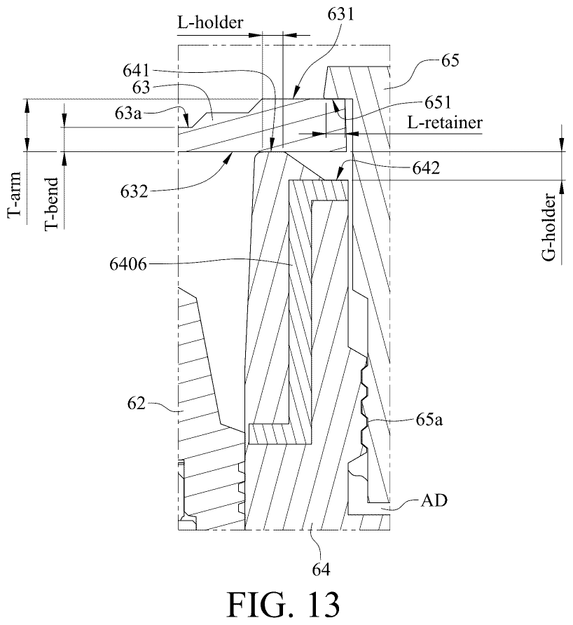

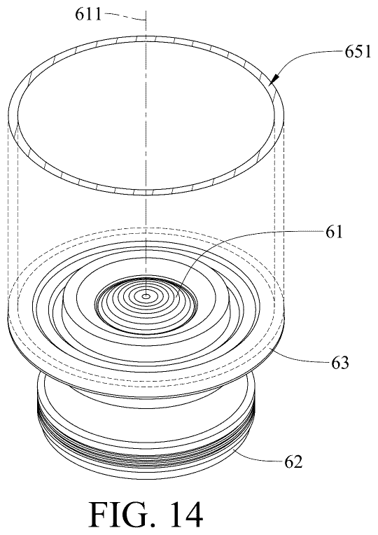

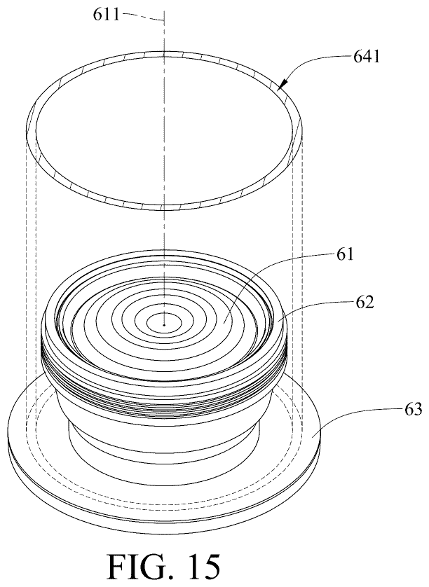

Please refer to FIG. 12 to FIG. 15, where FIG. 12 is a cross-sectional view of an imaging lens according to the 6th embodiment of the present disclosure, FIG. 13 is an enlarged view of GG region of the imaging lens of FIG. 12, FIG. 14 is a schematic view showing arrangement correspondence of elements of the imaging lens of FIG. 12, and FIG. 15 is a schematic view showing arrangement correspondence of another elements of the imaging lens of FIG. 12.

A camera module 6 provided in this embodiment includes an imaging lens 60 and an image sensing assembly 6a.

The imaging lens 60 includes a plurality of lens elements 61, a lens barrel 62, an arm 63, a holder 64 and a retainer 65. The lens elements 61 form a lens assembly (not numbered).

The lens elements 61 have an optical axis 611. The lens elements 61 are arranged along the optical axis 611. The lens barrel 62 accommodates (or carries) the lens elements 61. It can be also considered that the lens barrel 62 has a cylindrical wall 621 surrounding the lens elements 61. Please note that the quantity and the shapes of the lens elements 61 shown in the drawings are exemplary only, and some contours thereof are omitted to prevent obscuring the present disclosure. The present disclosure is not limited to the quantity and the shapes of the lens elements 61 in the drawings.

The arm 63 is disposed on a side of the lens barrel 62 away from the optical axis 611. The arm 63 extends from the cylindrical wall 621 of the lens barrel 62 along a direction away from the optical axis 611. In this embodiment, the arm 63 is integrally formed with the lens barrel 62, and the boundary between the arm 63 and the lens barrel 62 is shown by dash lines in FIG. 12 for distinguishing the arm 63 from the lens barrel 62. In this embodiment, a distance between the arm 63 and an object end of the lens barrel 62 is less than a distance between the arm 63 and an image end of the lens barrel 62. The arm 63 has an arm top surface 631 facing towards an object side and an arm bottom surface 632 facing towards an image side.

The holder 64 is configured for the cylindrical wall 621 of the lens barrel 62 to be disposed thereon so as to correspond the lens barrel 62 to the image sensing assembly 6a. The holder 64 has a first contacting surface 641 overlapped with and in contact with the arm 63 in a direction parallel to the optical axis 611. Please refer to FIG. 15, which is a schematic view showing arrangement correspondence of the overlapped first contacting surface 641 and arm 63. The first contacting surface 641 is in a loop shape surrounding the optical axis 611. Please note that only the part of the holder 64 forming the first contacting surface 641 is depicted in FIG. 15 for a clear display of the arrangement correspondence of the components.

The holder 64 has a strengthening element 6406 overlapped with the first contacting surface 641 in a direction parallel to the optical axis 611.

The retainer 65 is fixed on the holder 64 through structural mounting, with adhesive AD applied therebetween to secure the fixed relationship thereof. The retainer 65 has a second contacting surface 651 overlapped with and in contact with the arm 63 in a direction parallel to the optical axis 611. Please refer to FIG. 14, which is a schematic view showing arrangement correspondence of the overlapped second contacting surface 651 and arm 63. The second contacting surface 651 is in a loop shape surrounding the optical axis 611. Please note that only the part of the retainer 65 forming the second contacting surface 651 is depicted in FIG. 14 for a clear display of the arrangement correspondence of the components. Please refer to FIG. 12 and FIG. 13, the second contacting surface 651 is located on an opposite side of the first contacting surface 641. The retainer 65 abuts on the arm 63 through the second contacting surface 651 to keep the arm 63 in constant contact with the first contacting surface 641. Moreover, the retainer 65 abuts on the arm top surface 631 and form the second contacting surface 651 as mentioned above.

In the imaging lens 60, the arm 63 is disposed between the holder 64 and the retainer 65, and one of the arm 63, the holder 64 and the retainer 65 is made of a material different from that of the other two of the arm 63, the holder 64 and the retainer 65. The first contacting surface 641 and the second contacting surface 651 surround the optical axis 611 and are non-overlapped with each other in a direction parallel to the optical axis 611.

The image sensing assembly 6a includes a carrying plate CR, an image sensor IS and a filter FT. The carrying plate CR is fixed on the holder 64 through adhesive dispensing via adhesive AD. The image sensor IS is disposed on the carrying plate CR and is located on the image side of the imaging lens 60. The filter FT is located on an object side of the image sensor IS.

When a coefficient of thermal expansion of the lens barrel 62 is α-barrel, a coefficient of thermal expansion of the arm 63 is α-arm, a coefficient of thermal expansion of the holder 64 is α-holder, a coefficient of thermal expansion of the holder 64 at 25° C. is α-holder25, a coefficient of thermal expansion of the holder 64 at 50° C. is α-holder50, and a coefficient of thermal expansion of the retainer 65 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm s α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 62 at 25° C. is α-barrel25, and a coefficient of thermal expansion of the retainer 65 at 25° C. is α-retainer25, the following condition is satisfied: α-retainer25<α-barrel25.

When a distance between the optical axis 611 and a side of the first contacting surface 641 close to the second contacting surface 651 is D-1tocenter, and a distance between the optical axis 611 and a side of the second contacting surface 651 close to the first contacting surface 641 is D-2tocenter, the following conditions are satisfied: D-1tocenter=5.07 mm; D-2tocenter=5.6 mm; |D-1tocenter− D-2tocenter|=0.53 mm; and |D-1tocenter−D-2tocenter|/(D-1tocenter+D-2tocenter)=0.0497.

When the distance between the arm 63 and the object end of the lens barrel 62 is D-armtotop, and the distance between the arm 63 and the image end of the lens barrel 62 is D-armtodown, the following conditions are satisfied: D-armtotop=0.455 mm; D-armtodown=5.15 mm; and D-armtotop<D-armtodown.

When a thickness of the lens barrel 62 along a direction parallel to the optical axis 611 is T-barrel, and a thickness of the arm 63 in parallel with the optical axis 611 between the first contacting surface 641 and the second contacting surface 651 is T-arm, the following conditions are satisfied: T-barrel=6.255 mm; T-arm=0.65 mm; and T-arm/T-barrel=0.104.

The arm 63 has a bending surface 63a located closer to the optical axis 611 than the first contacting surface 641 and the second contacting surface 651. When a minimum thickness of the arm 63 at the bending surface 63a along a direction parallel to the optical axis 611 is T-bend, and the thickness of the arm 63 in parallel with the optical axis 611 between the first contacting surface 641 and the second contacting surface 651 is T-arm, the following conditions are satisfied: T-bend=0.3 mm; T-arm=0.65 mm; and T-bend/T-arm=0.462. A thickness of the arm 63 along a direction parallel to the optical axis 611 gradually increases from a position where the bending surface 63a is located towards a position where the first contacting surface 641 is located.

The holder 64 further has a first recess surface 642 facing towards the arm 63. The first recess surface 642 is disposed adjacent to the first contacting surface 641 and spaced apart from the arm 63. When a distance in parallel with the optical axis 611 between the first recess surface 642 and the arm 63 is G-holder, the following condition is satisfied: G-holder=0.35 mm. A gap formed between the first recess surface 642 and the arm 63 corresponds to the second contacting surface 651 in a direction parallel to the optical axis 611.

The retainer 65 further has a mounting portion 65a fixed to the holder 64, and the retainer 65 is connected to the holder 64 through the mounting portion 65a. The mounting portion 65a and the holder 64 have matching convex-concave shapes at their respective fixed positions. When the thickness of the arm 63 in parallel with the optical axis 611 between the first contacting surface 641 and the second contacting surface 651 is T-arm, and a length in parallel with the optical axis 611 between the second contacting surface 651 and the mounting portion 65a is L-2tomount, the following conditions are satisfied: T-arm=0.65 mm; L-2tomount=3.18 mm; and T-arm/L-2tomount=0.204.

When a length of the first contacting surface 641 along a plane in parallel with the optical axis 611 is L-holder, and a length of the second contacting surface 651 along a plane in parallel with the optical axis is L-retainer, the following conditions are satisfied: L-holder=0.25 mm; L-retainer=0.23 mm; and L-retainer/L-holder=0.92.

In this embodiment, each of the first contacting surface 641 and the second contacting surface 651 is in a loop shape surrounding the optical axis 611. However, the present disclosure is not limited thereto. Please refer to the 7th embodiment in the following.

### 7th Embodiment

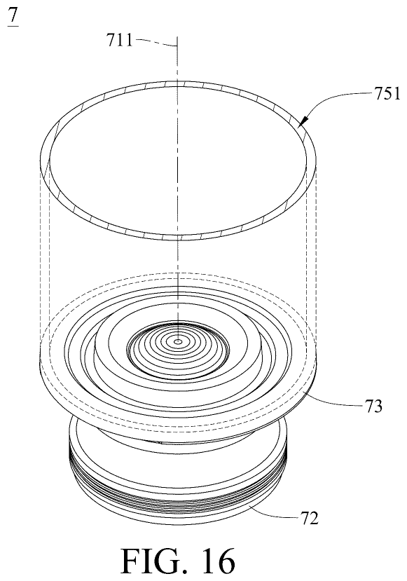

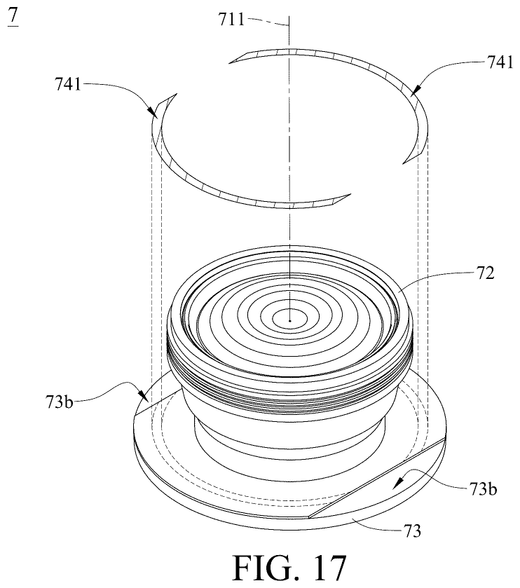

Please refer to FIG. 16 to FIG. 17, where FIG. 16 is a schematic view showing arrangement correspondence of elements of an imaging lens according to the 7th embodiment of the present disclosure, and FIG. 17 is a schematic view showing arrangement correspondence of another elements of the imaging lens of FIG. 16.

A camera module 7 provided in this embodiment is similar with the camera module 6 provided in the 6th embodiment. Therefore, descriptions of the same or similar features between the camera module 7 and the camera module 6 would be omitted.

In this embodiment, the arm 73 has two step structures (not numbered) on a side thereof close to an image end of the lens barrel 72. The step structures each have a lowered surface 73b. The holder (not numbered) is spaced apart from the arm 73 at the lowered surface 73b, and the first contacting surfaces 741 are in a multiple-arc shape surrounding the optical axis 711, as shown in FIG. 17.

In this embodiment, a side of the arm 73 close to the lens barrel 72 is still overlapped with the second contacting surface 751 of the retainer (not numbered) in a direction parallel to the optical axis 711, and the second contacting surface 751 is in a loop shape surrounding the optical axis 711, as shown in FIG. 16.

Please note that only the part of the holder forming the first contacting surface 741 and the part of the retainer forming the second contacting surface 751 are depicted in FIG. 16 and FIG. 17 for clear displays of the arrangement correspondences of the components.

### 8th Embodiment

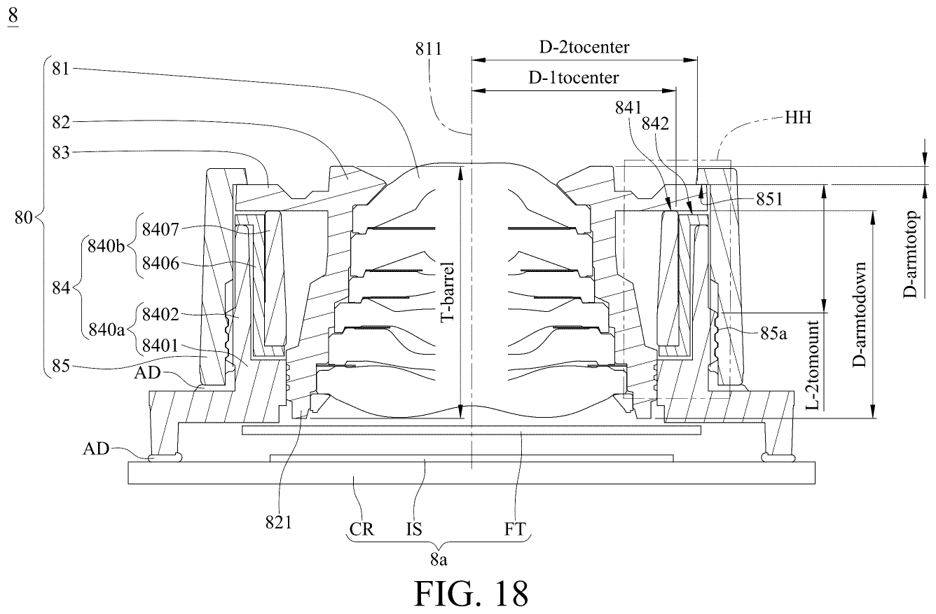

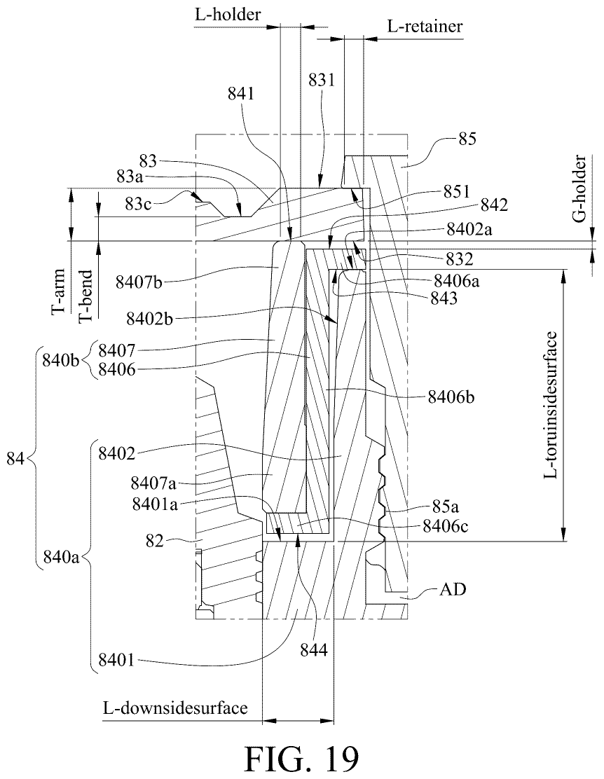

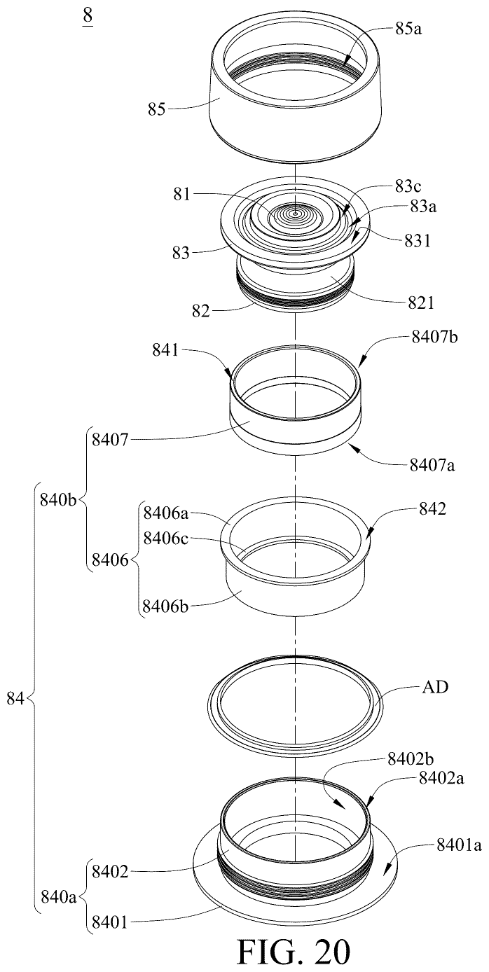

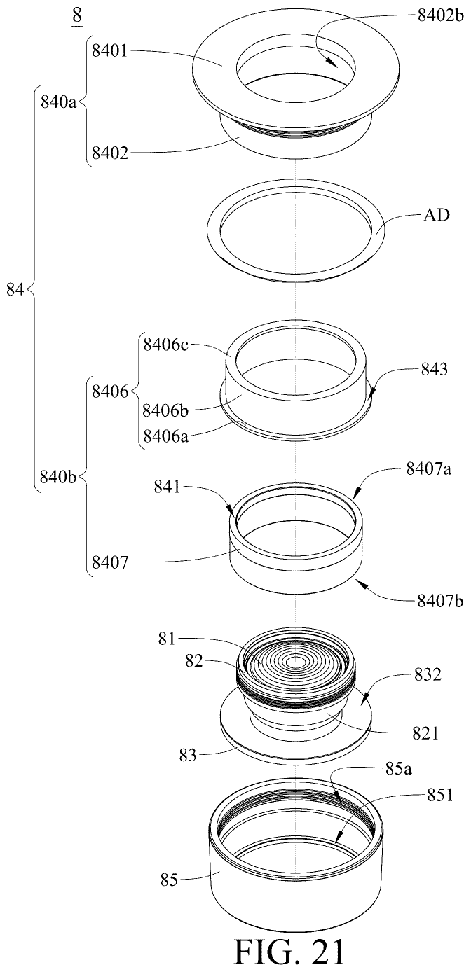

Please refer to FIG. 18 to FIG. 21, where FIG. 18 is a cross-sectional view of an imaging lens according to the 8th embodiment of the present disclosure, FIG. 19 is an enlarged view of HH region of the imaging lens of FIG. 18, FIG. 20 is an exploded view of the imaging lens of FIG. 18, and FIG. 21 is another exploded view of the imaging lens of FIG. 18.

A camera module 8 provided in this embodiment includes an imaging lens 80 and an image sensing assembly 8a.

The imaging lens 80 includes a plurality of lens elements 81, a lens barrel 82, an arm 83, a holder 84 and a retainer 85. The lens elements 81 form a lens assembly (not numbered).

The lens elements 81 have an optical axis 811. The lens elements 81 are arranged along the optical axis 811. The lens barrel 82 accommodates (or carries) the lens elements 81. It can be also considered that the lens barrel 82 has a cylindrical wall 821 surrounding the lens elements 81. Please note that the quantity and the shapes of the lens elements 81 shown in the drawings are exemplary only, and some contours thereof are omitted to prevent obscuring the present disclosure.

The present disclosure is not limited to the quantity and the shapes of the lens elements 81 in the drawings.

The arm 83 is disposed on a side of the lens barrel 82 away from the optical axis 811. The arm 83 extends from the cylindrical wall 821 of the lens barrel 82 along a direction away from the optical axis 811. In this embodiment, the arm 83 is integrally formed with the lens barrel 82, and the boundary between the arm 83 and the lens barrel 82 is shown by dash lines in FIG. 12 for distinguishing the arm 83 from the lens barrel 82. In this embodiment, a distance between the arm 83 and an object end of the lens barrel 82 is less than a distance between the arm 83 and an image end of the lens barrel 82. The arm 83 has an arm top surface 831 facing towards an object side and an arm bottom surface 832 facing towards an image side.

The holder 84 is configured for the cylindrical wall 821 of the lens barrel 82 to be disposed thereon so as to correspond the lens barrel 82 to the image sensing assembly 8a. The holder 84 has a first contacting surface 841 overlapped with and in contact with the arm 83 in a direction parallel to the optical axis 811. The first contacting surface 841 is in a loop shape surrounding the optical axis 811.

Specifically, the holder 84 includes a base 840a and a holder carrier 840b. The base 840a has a bottom portion 8401 and a surrounding wall 8402. The bottom portion 8401 has a bottom surface 8401a facing towards the arm 83. The surrounding wall 8402 extends from the bottom surface 8401a of the bottom portion 8401 towards the arm 83, and the surrounding wall 8402 has a surrounding top surface 8402a facing towards the arm 83 and a surrounding inner surface 8402b facing towards the lens barrel 82.

The holder carrier 840b is disposed on (or connected to) the base 840a. The holder carrier 840b has the first contacting surface 841 as mentioned above. The holder carrier 840b carries the lens barrel 82 through the first contacting surface 841 and the arm 83.

Specifically, the holder carrier 840b has a strengthening element 8406 and an extension portion 8407. The strengthening element 8406 is overlapped with the first contacting surface 841 in a direction parallel to the optical axis 811. The strengthening element 8406 includes a first abutting portion 8406a, a connecting portion 8406b and a second abutting portion 8406c. The first abutting portion 8406a has a third contacting surface 843. The first abutting portion 8406a abuts on the surrounding top surface 8402a of the surrounding wall 8402 through the third contacting surface 843. The connecting portion 8406b extends from the first abutting portion 8406a along a direction away from the arm 83. The second abutting portion 8406c is connected to the connecting portion 8406b. The second abutting portion 8406c is located further away from the arm 83 than the first abutting portion 8406a. Moreover, the strengthening element 8406 is located between the extension portion 8407 and the surrounding wall 8402.

The extension portion 8407 has a first end 8407a connected to the second abutting portion 8406c and a second end 8407b extending from the first end 8407a towards the arm 83. The first end 8407a is in contact with the strengthening element 8406 and forms a fourth contacting surface 844 located further away from the arm 83 than the third contacting surface 843. The second end 8407b is in contact with the arm bottom surface 832 and forms the first contacting surface 841 as mentioned above. Moreover, the extension portion 8407 is configured to move the first contacting surface 841 of the holder 84 along a direction parallel to the optical axis 811.

The retainer 85 is fixed on the holder 84 through structural mounting, with adhesive AD applied therebetween to secure the fixed relationship thereof. The retainer 85 has a second contacting surface 851 overlapped with and in contact with the arm 83 in a direction parallel to the optical axis 811. The second contacting surface 851 is in a loop shape surrounding the optical axis 811. The second contacting surface 851 is located on an opposite side of the first contacting surface 841. The retainer 85 abuts on the arm 83 through the second contacting surface 851 to keep the arm 83 in constant contact with the first contacting surface 841. Moreover, the retainer 85 abuts on the arm top surface 831 and form the second contacting surface 851 as mentioned above.

In the imaging lens 80, the arm 83 is disposed between the holder 84 and the retainer 85, and one of the arm 83, the holder 84 and the retainer 85 is made of a material different from that of the other two of the arm 83, the holder 84 and the retainer 85. The first contacting surface 841 and the second contacting surface 851 surround the optical axis 811 and are non-overlapped with each other in a direction parallel to the optical axis 811.

The image sensing assembly 8a includes a carrying plate CR, an image sensor IS and a filter FT. The carrying plate CR is fixed on the holder 84 through adhesive dispensing via adhesive AD. The image sensor IS is disposed on the carrying plate CR and is located on the image side of the imaging lens 80. The filter FT is located on an object side of the image sensor IS.

When a coefficient of thermal expansion of the lens barrel 82 is α-barrel, a coefficient of thermal expansion of the arm 83 is α-arm, a coefficient of thermal expansion of the holder 84 is α-holder, a coefficient of thermal expansion of the holder 84 at 25° C. is α-holder25, a coefficient of thermal expansion of the holder 84 at 50° C. is α-holder50, and a coefficient of thermal expansion of the retainer 85 is α-retainer, the following conditions are satisfied: α-retainer<α-holder; 1.01≤α-holder50/α-holder25≤3.63; 30 ppm/° C.<α-holder−α-retainer<240 ppm/° C.; α-retainer<α-arm; and α-retainer<α-arm α-barrel<α-holder. Please note that the values in abovementioned Table 1 and Table 2 can be chosen as the values of α-barrel, α-holder, α-holder25, α-holder50 and α-retainer, and α-arm and α-barrel can have the same value.

When a coefficient of thermal expansion of the lens barrel 82 at 25° C. is α-barrel25, and a coefficient of thermal expansion of the retainer 85 at 25° C. is α-retainer25, the following condition is satisfied: α-retainer25<α-barrel25.

When a coefficient of thermal expansion of the extension portion 8407 is α-extension, and a coefficient of thermal expansion of the retainer 85 at 25° C. is α-retainer25, the following condition can be satisfied: 30 ppm/° C. s α-extension-α-retainer25≤240 ppm/° C.

When a distance between the optical axis 811 and a side of the first contacting surface 841 close to the second contacting surface 851 is D-1tocenter, and a distance between the optical axis 811 and a side of the second contacting surface 851 close to the first contacting surface 841 is D-2tocenter, the following conditions are satisfied: D-1tocenter=5.07 mm; D-2tocenter=5.6 mm; |D-1tocenter− D-2tocenter|=0.53 mm; and |D-1tocenter−D-2tocenter|/(D-1tocenter+D-2tocenter)=0.0497.

When the distance between the arm 83 and the object end of the lens barrel 82 is D-armtotop, and the distance between the arm 83 and the image end of the lens barrel 82 is D-armtodown, the following conditions are satisfied: D-armtotop=0.455 mm; D-armtodown=5.15 mm; and D-armtotop<D-armtodown.

When a thickness of the lens barrel 82 along a direction parallel to the optical axis 811 is T-barrel, and a thickness of the arm 83 in parallel with the optical axis 811 between the first contacting surface 841 and the second contacting surface 851 is T-arm, the following conditions are satisfied: T-barrel=6.255 mm; T-arm=0.65 mm; and T-arm/T-barrel=0.104.

The arm 83 has a bending surface 83a located closer to the optical axis 811 than the first contacting surface 841 and the second contacting surface 851. When a minimum thickness of the arm 83 at the bending surface 83a along a direction parallel to the optical axis 811 is T-bend, and the thickness of the arm 83 in parallel with the optical axis 811 between the first contacting surface 841 and the second contacting surface 851 is T-arm, the following conditions are satisfied: T-bend=0.3 mm; T-arm=0.65 mm; and T-bend/T-arm=0.462. A thickness of the arm 83 along a direction parallel to the optical axis 811 gradually increases from a position where the bending surface 83a is located towards a position where the first contacting surface 841 is located. The arm 83 further has a flat surface 83c perpendicular to the optical axis 811 and located closer to the optical axis 811 than the bending surface 83a. A thickness of the arm 83 at the flat surface 83c along a direction parallel to the optical axis 811 is greater than a thickness of the arm 83 at the bending surface 83a along a direction parallel to the optical axis 811.

The first abutting portion 8406a of the holder 84 further has a first recess surface 842 facing towards the arm 83. The first recess surface 842 is disposed adjacent to the first contacting surface 841 and spaced apart from the arm 83. When a distance in parallel with the optical axis 811 between the first recess surface 842 and the arm 83 is G-holder, the following condition is satisfied: G-holder=0.1 mm. A gap formed between the first recess surface 842 and the arm 83 corresponds to the second contacting surface 851 in a direction parallel to the optical axis 811.

The retainer 85 further has a mounting portion 85a fixed to the holder 84, and the retainer 85 is connected to the holder 84 through the mounting portion 85a. The mounting portion 85a and the holder 84 have matching convex-concave shapes at their respective fixed positions. When the thickness of the arm 83 in parallel with the optical axis 811 between the first contacting surface 841 and the second contacting surface 851 is T-arm, and a length in parallel with the optical axis 811 between the second contacting surface 851 and the mounting portion 85a is L-2tomount, the following conditions are satisfied: T-arm=0.65 mm; L-2tomount=3.18 mm; and T-arm/L-2tomount=0.204.

When a length of the first contacting surface 841 along a plane in parallel with the optical axis 811 is L-holder, and a length of the second contacting surface 851 along a plane in parallel with the optical axis is L-retainer, the following conditions are satisfied: L-holder=0.25 mm; L-retainer=0.2378 mm; and L-retainer/L-holder=0.951.

When a length of the surrounding inner surface 8402b along a direction parallel to the optical axis 811 is L-toruinsidesurface, and a length of the bottom surface 8401 a along a direction parallel to the optical axis 811 is L-downsidesurface, the following condition is satisfied: L-toruinsidesurface>L-downsidesurface.

In this embodiment, each of the first contacting surface 841 and the second contacting surface 851 is in a loop shape surrounding the optical axis 811. However, the present disclosure is not limited thereto. Please refer to the 9th embodiment in the following.

### 9th Embodiment

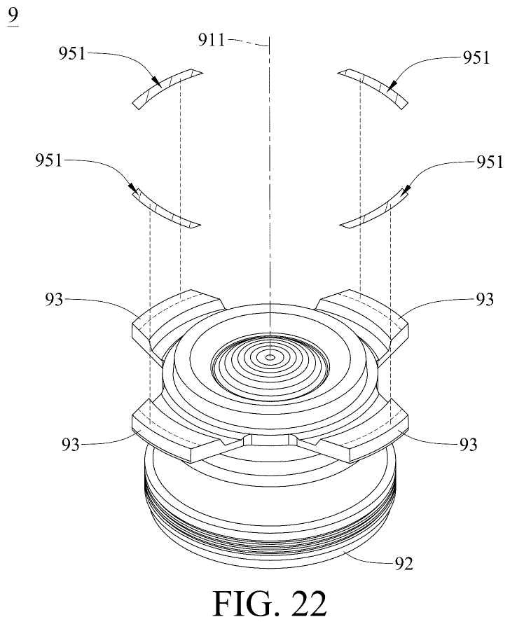

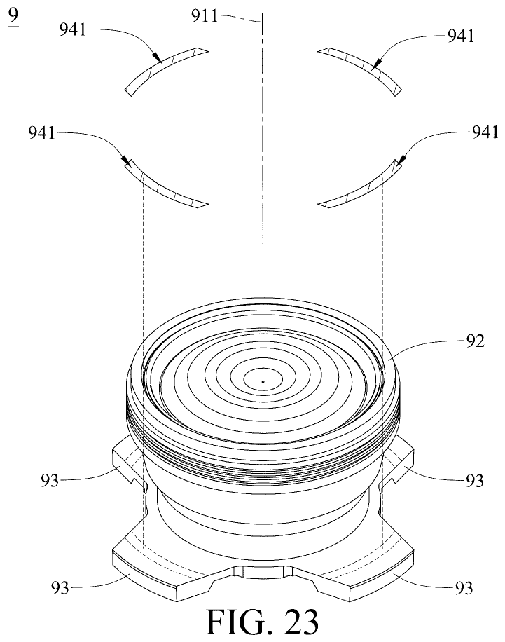

Please refer to FIG. 22 to FIG. 23, where FIG. 22 is a schematic view showing arrangement correspondence of elements of an imaging lens according to the 9th embodiment of the present disclosure, and FIG. 23 is a schematic view showing arrangement correspondence of another elements of the imaging lens of FIG. 22.

A camera module 9 provided in this embodiment is similar with the camera module 8 provided in the 8th embodiment. Therefore, descriptions of the same or similar features between the camera module 9 and the camera module 8 would be omitted.

In this embodiment, the quantity of the arms 93 is four. The arms 93 are evenly arranged on a side of the lens barrel 92 away from the optical axis 911 in a circumferential direction surrounding the optical axis 911, such that the first contacting surfaces 941 shown in FIG. 23 are in a multiple-arc shape surrounding the optical axis 911, and the second contacting surfaces 951 shown in FIG. 22 are in a multiple-arc shape surrounding the optical axis 911.

Please note that only the part of the holder (not numbered) forming the first contacting surface 941 and the part of the retainer (not numbered) forming the second contacting surface 951 are depicted in FIG. 22 and FIG. 23 for clear displays of the arrangement correspondences of the components.

### 10th Embodiment

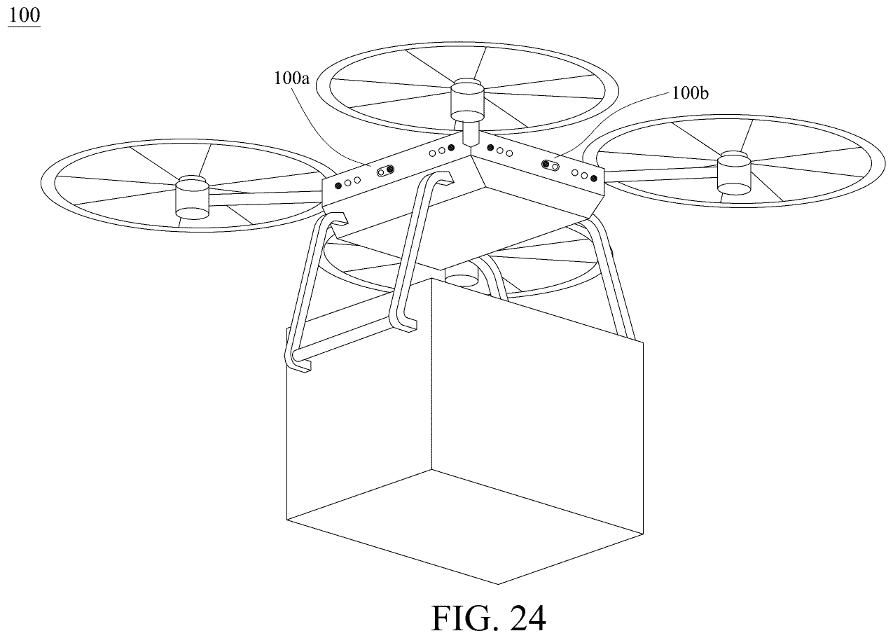

Please refer to FIG. 24, which is a perspective view of an electronic device according to the 10th embodiment of the present disclosure.

An electronic device 100 provided in this embodiment may be an unmanned aerial vehicle. The electronic device 100 includes a side camera module 100a and a front camera module 100b. The side camera module 100a and the front camera module 100b each include one of the camera modules 1-9 of the present disclosure so as to provide reliable optical quality and environmental durability of photography for the electronic device 100.

### 11th Embodiment

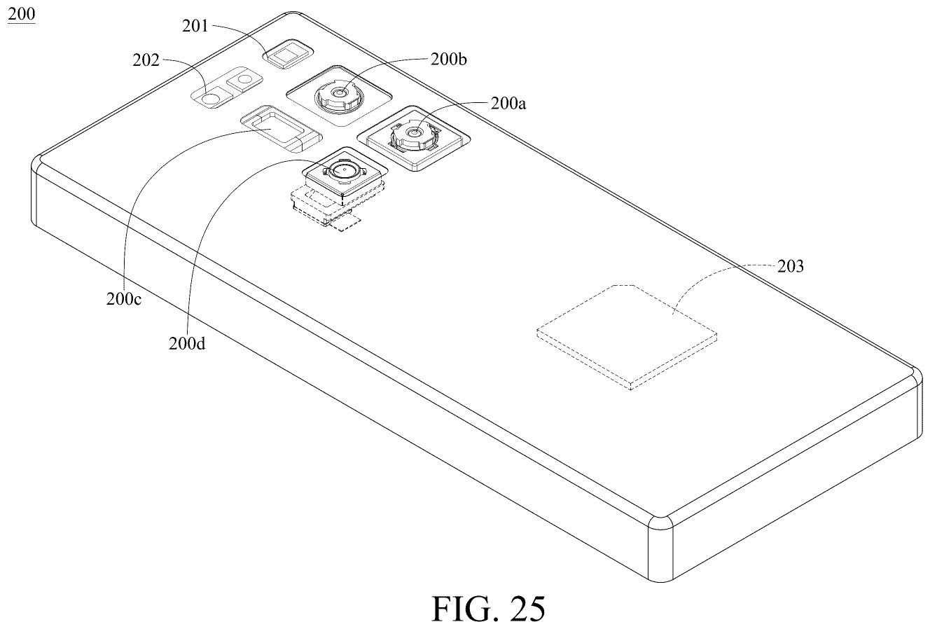

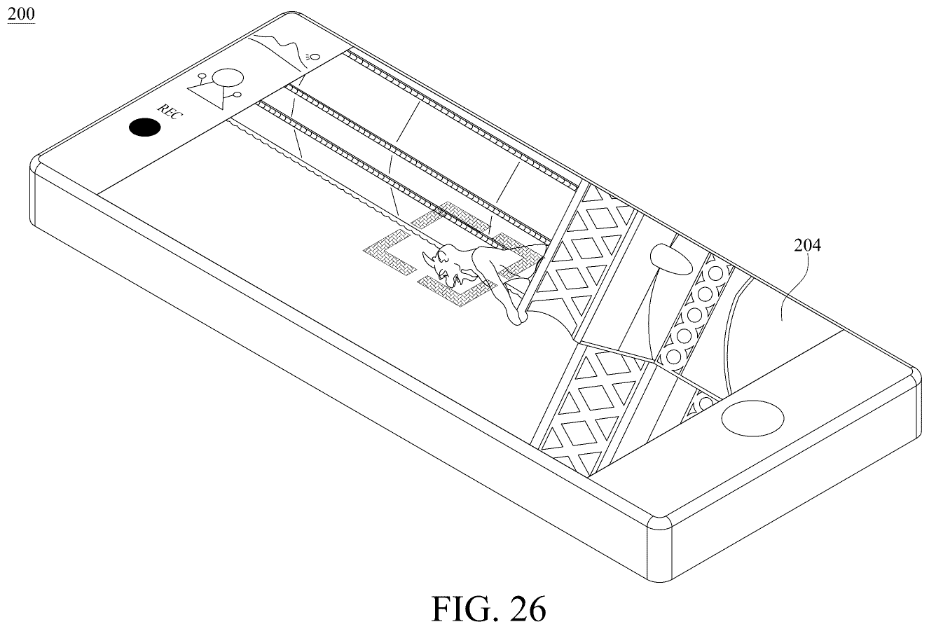

Please refer to FIG. 25 and FIG. 26. FIG. 25 is a perspective view of an electronic device according to the 11th embodiment of the present disclosure, and FIG. 26 is another perspective view of the electronic device in FIG. 25.

In this embodiment, the electronic device 200 is a smartphone including a plurality of camera modules, a flash module 201, a focus assist module 202, an image signal processor 203, a display module (user interface) 204 and an image software processor (not shown).

These camera modules include an ultra-wide-angle camera module 200a, a high pixel camera module 200b, a telephoto camera module 200c and a telephoto camera module 200d. Moreover, the camera module 200b includes, for example, one of the camera modules 1-9 as disclosed in the present disclosure, but the present disclosure is not limited thereto. At least one of the camera modules 200a, 200c, and 200d can include one of the camera modules 1-9 of the present disclosure.

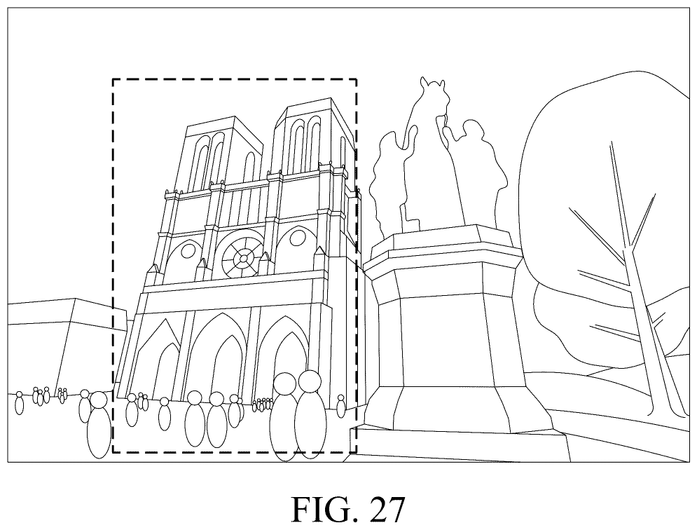

The image captured by the ultra-wide-angle camera module 200a enjoys a feature of multiple imaged objects. FIG. 27 is an illustration of an image captured by the ultra-wide-angle camera module 200a.

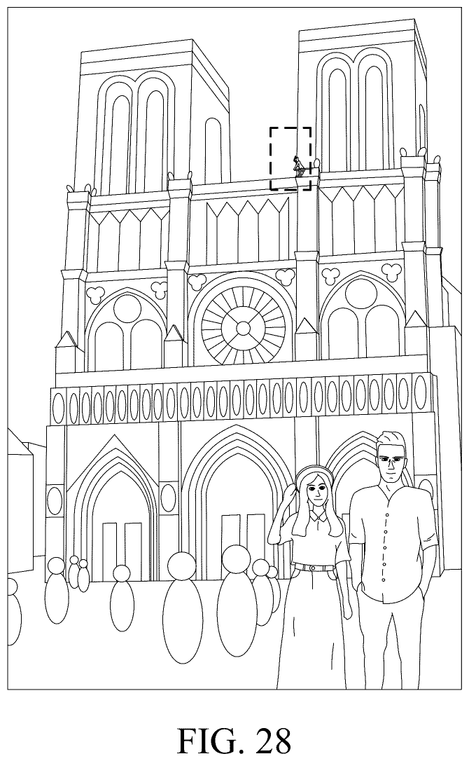

The image captured by the high pixel camera module 200b enjoys a feature of high resolution and less distortion, and the high pixel camera module 200b can capture part of the image in FIG. 27. FIG. 28 is an illustration of an image captured by the high pixel camera module 200b.

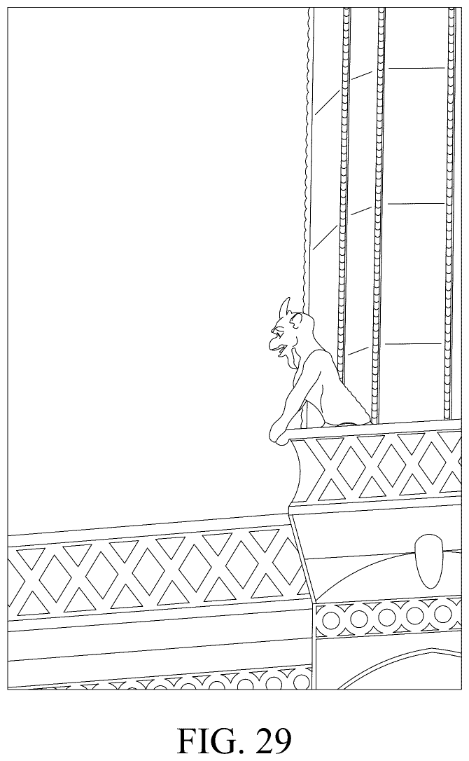

The image captured by the telephoto camera module 200c or the telephoto camera module 200d enjoys a feature of high optical magnification, and the telephoto camera module 200c or the telephoto camera module 200d can capture part of the image in FIG. 28. FIG. 29 is an illustration of an image captured by the telephoto camera module 200c or the telephoto camera module 200d.

When a user captures images of an object, the light rays converge in the ultra-wide-angle camera module 200a, the high pixel camera module 200b, the telephoto camera module 200c or the telephoto camera module 200d to generate an image, and the flash module 201 is activated for light supplement. The focus assist module 202 detects the object distance of the imaged object to achieve fast auto focusing.

The image signal processor 203 is configured to optimize the captured image to improve image quality and provide zooming function. The light beam emitted from the focus assist module 202 can be either conventional infrared or laser. The display module 204 can include a touch screen, and the user is able to interact with the display module 204 to adjust the angle of view and switch between different camera modules, and the image software processor having multiple functions to capture images and complete image processing. Alternatively, the user may capture images via a physical button. The image processed by the image software processor can be displayed on the display module 204.

### 12th Embodiment

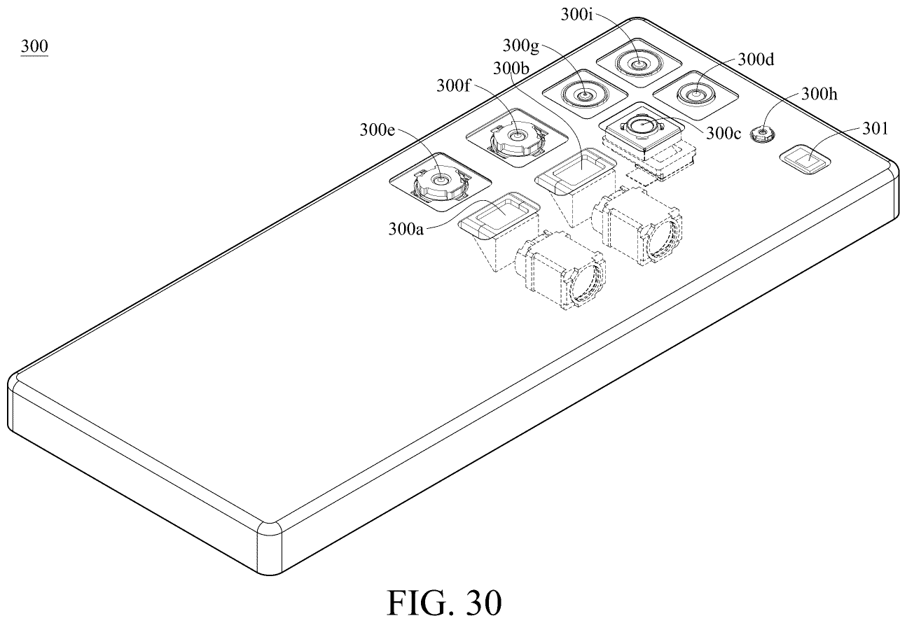

Please refer to FIG. 30, which is a perspective view of an electronic device according to the 12th embodiment of the present disclosure.

In this embodiment, the electronic device 300 is a smartphone including a camera module 300a, a camera module 300b, a camera module 300c, a camera module 300d, a camera module 300e, a camera module 300f, a camera module 300g, a camera module 300h, a camera module 300i, a flash module 301, an image signal processor, a display module and an image software processor (not shown).

The camera module 300a, the camera module 300b, the camera module 300c, the camera module 300d, the camera module 300e, the camera module 300f, the camera module 300g, the camera module 300h and the camera module 300i are disposed on the same side of the electronic device 300, while the display module is disposed on the opposite side of the electronic device 300. Moreover, the camera module 300e includes, for example, one of the camera modules 1-9 as disclosed in the present disclosure, but the present disclosure is not limited thereto. At least one of the camera modules 300a, 300b, 300c, 300d, 300f, 300g, 300h, and 300i can include one of the camera modules 1-9 of the present disclosure.

The camera module 300a is a telephoto camera module, the camera module 300b is a telephoto camera module, the camera module 300c is a telephoto camera module, the camera module 300d is a telephoto camera module, the camera module 300e is a wide-angle camera module, the camera module 300f is a wide-angle camera module, the camera module 300g is a ultra-wide-angle camera module, the camera module 300h is a ToF (time of flight) camera module, and the camera module 300i is an ultra-wide-angle camera module. In this embodiment, the camera module 300i, the camera module 300a, the camera module 300b, the camera module 300c, the camera module 300d, the camera module 300e, the camera module 300f and the camera module 300g have different fields of view, such that the electronic device 300 can have various magnification ratios so as to meet the requirement of optical zoom functionality. In addition, the camera module 300a and camera module 300b are telephoto camera modules having a light-folding element configuration. In addition, the camera module 300h can determine depth information of the imaged object. In this embodiment, the electronic device 300 includes multiple camera modules 300a, 300b, 300c, 300d, 300e, 300f, 300g, 300h, and 300i, but the present disclosure is not limited to the quantity and arrangement of camera modules. When a user captures images of an object, the light rays converge in the camera module 300a, the camera module 300b, the camera module 300c, the camera module 300d, the camera module 300e, the camera module 300f, the camera module 300g, the camera module 300h or the camera module 300i to generate an image(s), and the flash module 301 is activated for light supplement. Further, the subsequent processes are performed in a manner similar to the abovementioned embodiments, so the details in this regard will not be provided again.

### 13th Embodiment

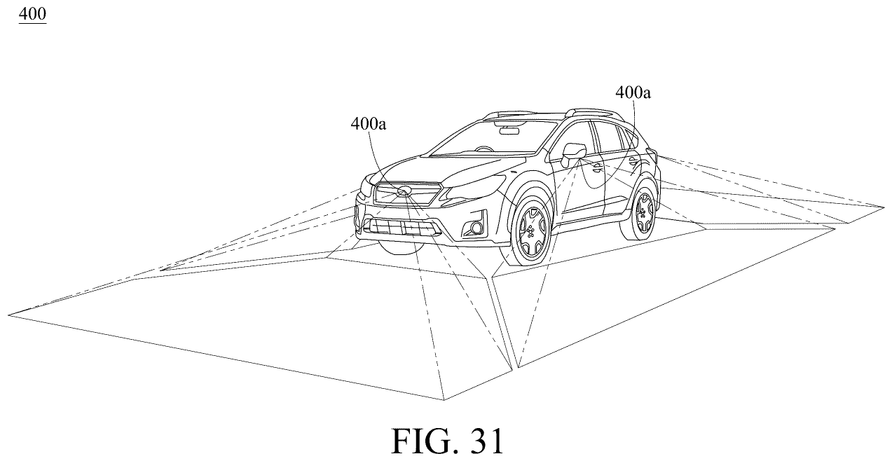

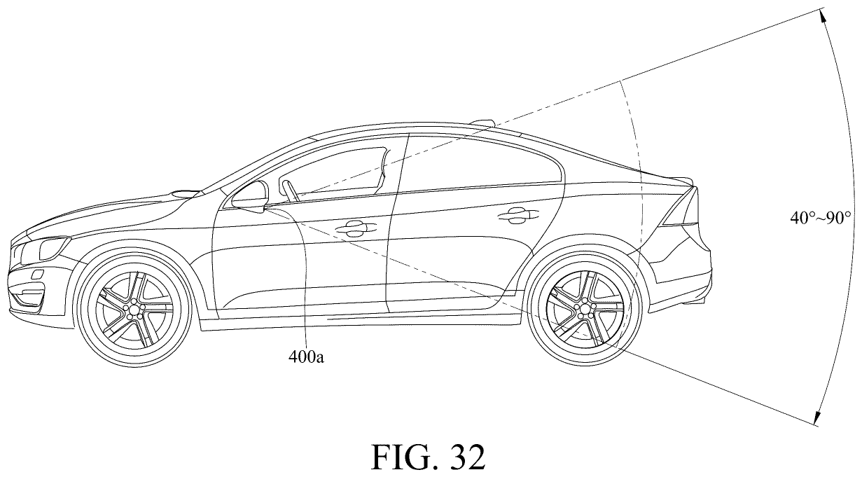

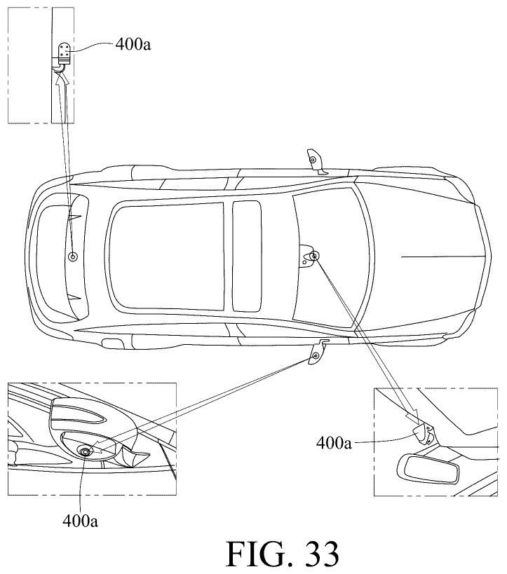

Please refer to FIG. 31 to FIG. 33. FIG. 31 is a perspective view of an electronic device according to the 13th embodiment of the present disclosure, FIG. 32 is a side view of the electronic device in FIG. 31, and FIG. 33 is a top view of the electronic device in FIG. 31.

In this embodiment, the electronic device 400 is an automobile. The electronic device 400 includes a plurality of automotive camera modules 400a, and the camera modules 400a each include the camera modules 1-9 of the present disclosure. The camera modules 400a can serve as, for example, panoramic view car cameras, dashboard cameras and vehicle backup cameras.

As shown in FIG. 31, the camera modules 400a are, for example, disposed around the automobile to capture peripheral images of the automobile, which is favorable for obtaining external traffic information so as to achieve autopilot function.

In addition, the image software processor may stitch the peripheral images into one panoramic view image for the driver's checking every corner surrounding the automobile, thereby favorable for parking and driving.

As shown in FIG. 32, the camera modules 400a are, for example, respectively disposed on the lower portion of the side mirrors. A maximum field of view of the camera modules 400a can be 40 degrees to 90 degrees for capturing images in regions on left and right lanes.

As shown in FIG. 33, the camera modules 400a can also be, for example, respectively disposed on the lower portion of the side mirrors and inside the front and rear windshields for providing external information to the driver, and also providing more viewing angles so as to reduce blind spots, thereby improving driving safety.

The unmanned aerial vehicle, smartphones, panoramic view car cameras, dashboard cameras and vehicle backup cameras in the embodiments are only exemplary for showing the camera module of the present disclosure installed in an electronic device, and the present disclosure is not limited thereto. The camera module can be optionally applied to optical systems with a movable focus.

Furthermore, the camera module features good capability in aberration corrections and high image quality, and can be applied to 3D (three-dimensional) image capturing applications, in products such as digital cameras, mobile devices, digital tablets, smart televisions, network surveillance devices, multi-camera devices, image recognition systems, motion sensing input devices, wearable devices and other electronic imaging devices.

The foregoing description, for the purpose of explanation, has been described with reference to specific embodiments. It is to be noted that the present disclosure shows different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An imaging lens comprising:
at least one lens element having an optical axis;
a lens barrel accommodating the at least one lens element;
an arm disposed on a side of the lens barrel away from the optical axis, wherein the arm extends along a direction away from the optical axis;
a holder having a first contacting surface that is overlapped with and is in contact with the arm in a direction parallel to the optical axis; and
a retainer fixed on the holder, wherein the retainer has a second contacting surface being overlapped with and being in contact with the arm in a direction parallel to the optical axis, and the second contacting surface is located on an opposite side of the first contacting surface;
wherein the arm is disposed between the holder and the retainer;
wherein the holder and the retainer are made of different materials;
wherein the first contacting surface and the second contacting surface surround the optical axis and are non-overlapped with each other in a direction parallel to the optical axis;
wherein a coefficient of thermal expansion of the holder is α-holder, a coefficient of thermal expansion of the retainer is α-retainer, and the following condition is satisfied:
$$α - retainer < α - holder ;$$
wherein a distance between the optical axis and a side of the first contacting surface close to the second contacting surface is D-1tocenter, a distance between the optical axis and a side of the second contacting surface close to the first contacting surface is D-2tocenter, and the following condition is satisfied:
$$0.05 mm \leq \vert D - 1 tocenter - D - 2 tocenter \vert \leq 1.8 mm .$$

2. The imaging lens according to claim 1, wherein the distance between the optical axis and the side of the first contacting surface close to the second contacting surface is D-1tocenter, the distance between the optical axis and the side of the second contacting surface close to the first contacting surface is D-2tocenter, and the following condition is satisfied:
$$0.01 \leq \vert D - 1 tocenter - D - 2 tocenter \vert / ( D - 1 tocenter + D - 2 tocenter ) \leq 0.14 5 .$$

3. The imaging lens according to claim 1, wherein a coefficient of thermal expansion of the holder at 25° C. is α-holder25, a coefficient of thermal expansion of the holder at 50° C. is α-holder50, and the following condition is satisfied:
$$1.01 \leq α - holder 50 / α - holder 25 \leq 3.63 .$$

4. The imaging lens according to claim 1, wherein the coefficient of thermal expansion of the holder is α-holder, the coefficient of thermal expansion of the retainer is α-retainer, and the following condition is satisfied:
$$30 ppm / °C . < α - holder - α - retainer < 240 ppm / °C .$$

5. The imaging lens according to claim 1, wherein the coefficient of thermal expansion of the retainer is α-retainer, a coefficient of thermal expansion of the arm is α-arm, and the following condition is satisfied:
$$α - retainer \leq α - arm .$$

6. The imaging lens according to claim 1, wherein the coefficient of thermal expansion of the retainer is α-retainer, a coefficient of thermal expansion of the arm is α-arm, a coefficient of thermal expansion of the lens barrel is α-barrel, the coefficient of thermal expansion of the holder is α-holder, and the following condition is satisfied:
$$α - retainer < α - arm \leq α - barrel < α - holder .$$

7. The imaging lens according to claim 1, wherein a thickness of the arm in parallel with the optical axis between the first contacting surface and the second contacting surface is T-arm, and the following condition is satisfied:
$$0.15 mm \leq T - arm \leq 1.5 mm .$$

8. The imaging lens according to claim 1, wherein the arm has a bending surface located closer to the optical axis than the first contacting surface and the second contacting surface,
wherein a minimum thickness of the arm at the bending surface along a direction parallel to the optical axis is T-bend, a thickness of the arm in parallel with the optical axis between the first contacting surface and the second contacting surface is T-arm, and the following condition is satisfied:
$$0.333 \leq T - bend / T - arm \leq 0.885 .$$

9. The imaging lens according to claim 1, wherein a thickness of the arm in parallel with the optical axis between the first contacting surface and the second contacting surface is T-arm, a thickness of the lens barrel along a direction parallel to the optical axis is T-barrel, and the following condition is satisfied:
$$0.035 \leq T - arm / T - barrel \leq 0.18 .$$

10. The imaging lens according to claim 1, wherein the holder further has a first recess surface being disposed adjacent to the first contacting surface and being spaced apart from the arm;
wherein a distance in parallel with the optical axis between the first recess surface and the arm is G-holder, and the following condition is satisfied:
$$0.01 mm \leq G - holder \leq 0.4 mm .$$

11. The imaging lens according to claim 10, further comprising an insertion element being disposed between the first recess surface and the arm and being in contact with the first recess surface and the arm.

12. The imaging lens according to claim 1, wherein the retainer further has a second recess surface being disposed adjacent to the second contacting surface and being spaced apart from the arm;
wherein a distance in parallel with the optical axis between the second recess surface and the arm is G-retainer, and the following condition is satisfied:
0.01 mm≤G-retainer≤0.4 mm.

13. The imaging lens according to claim 1, wherein the retainer further has a mounting portion fixed to the holder,
wherein a thickness of the arm in parallel with the optical axis between the first contacting surface and the second contacting surface is T-arm, a length in parallel with the optical axis between the second contacting surface and the mounting portion is L-2tomount, and the following condition is satisfied:
0.042≤T-arm/L-2tomount≤0.775.

14. The imaging lens according to claim 1, wherein the holder has an inner surface facing towards the optical axis, the inner surface and the lens barrel form an air gap therebetween, and the air gap is overlapped with the at least one lens element along a direction perpendicular to the optical axis.

15. The imaging lens according to claim 1, wherein the arm and the lens barrel are integrally formed.

16. The imaging lens according to claim 1, wherein a distance between the arm and an object end of the lens barrel is less than a distance between the arm and an image end of the lens barrel.

17. The imaging lens according to claim 1, further comprising a connector formed on the arm, wherein the connector surrounds the optical axis and forms a light-passable hole located at a position where an aperture of the imaging lens is located.

18. The imaging lens according to claim 1, wherein a length of the second contacting surface along a plane in parallel with the optical axis is L-retainer, a length of the first contacting surface along a plane in parallel with the optical axis is L-holder, and the following condition is satisfied:
$$0.2 < L - retainer / L - holder < 5.$$

19. The imaging lens according to claim 1, wherein the at least one lens element comprises a plastic lens element and a glass lens element.

20. A camera module comprising:
the imaging lens of claim 1; and
an image sensing assembly comprising an image sensor disposed on an image side of the imaging lens;
wherein the holder of the imaging lens is fixed to the image sensing assembly.

21. An electronic device comprising:
the camera module of claim 20.

22. A camera module comprising:
a lens assembly having a plurality of lens elements that are disposed along an optical axis;
a lens barrel carrying the lens assembly;
an arm extending from the lens barrel along a direction away from the optical axis;
an image sensor disposed on an image side of the lens assembly;
a holder on which the lens barrel is disposed so as to correspond the lens barrel to the image sensor, wherein the holder has a first contacting surface surrounding the optical axis and being in contact with the arm; and
a retainer fixed on the holder so as to fix the lens barrel to the holder, wherein the retainer has a second contacting surface surrounding the optical axis and being in contact with the arm so as to keep the arm in constant contact with the first contacting surface;
wherein the arm is disposed between the holder and the retainer;
wherein one of the arm, the holder and the retainer is made of a material different from that of the other two of the arm, the holder and the retainer;
wherein the first contacting surface and the second contacting surface are non-overlapped with each other in a direction parallel to the optical axis;
wherein a distance between the optical axis and a side of the first contacting surface close to the second contacting surface is D-1tocenter, a distance between the optical axis and a side of the second contacting surface close to the first contacting surface is D-2tocenter, and the following condition is satisfied:
$$0.05 mm \leq \vert D - 1 tocenter - D - 2 tocenter \vert \leq 1.8 mm .$$

23. The camera module according to claim 22, wherein the distance between the optical axis and the side of the first contacting surface close to the second contacting surface is D-1tocenter, the distance between the optical axis and the side of the second contacting surface close to the first contacting surface is D-2tocenter, and the following condition is satisfied:
$$0.01 \leq \vert D - 1 tocenter - D - 2 tocenter \vert / ( D - 1 tocenter + D - 2 tocenter ) \leq 0.145 .$$

24. The camera module according to claim 22, wherein the holder has an extension portion configured to move the first contacting surface of the holder along a direction parallel to the optical axis;
wherein a coefficient of thermal expansion of the extension portion is α-extension, a coefficient of thermal expansion of the retainer at 25° C. is α-retainer25, and the following condition is satisfied:
$$30 ppm / °C . < α - extension - α - retainer 25 \leq 240 ppm / °C .$$

25. The camera module according to claim 22, wherein the holder has an extension portion configured to move the first contacting surface of the holder along a direction parallel to the optical axis, and the extension portion has a coefficient of thermal expansion varying with temperature;
wherein a coefficient of thermal expansion of the holder at 25° C. is α-holder25, a coefficient of thermal expansion of the holder at 50° C. is α-holder50, and the following condition is satisfied:
$$1.01 \leq α - holder 50 / α - holder 25 \leq 3.63 .$$

26. The camera module according to claim 22, wherein a coefficient of thermal expansion of the lens barrel at 25° C. is α-barrel25, a coefficient of thermal expansion of the retainer at 25° C. is α-retainer25, and the following condition is satisfied:
$$α - retainer 25 < α - barrel 25.$$

27. The camera module according to claim 22, wherein a thickness of the arm in parallel with the optical axis between the first contacting surface and the second contacting surface is T-arm, and the following condition is satisfied:
$$0.15 mm \leq T - arm \leq 1.5 mm .$$

28. The camera module according to claim 22, wherein the arm has a bending surface located closer to the optical axis than the first contacting surface and the second contacting surface,
wherein a minimum thickness of the arm at the bending surface along a direction parallel to the optical axis is T-bend, a thickness of the arm in parallel with the optical axis between the first contacting surface and the second contacting surface is T-arm, and the following condition is satisfied:
$$0.333 \leq T - bend / T - arm \leq 0.885 .$$

29. The camera module according to claim 28, wherein the arm further has a flat surface being perpendicular to the optical axis and being located closer to the optical axis than the bending surface, and a thickness of the arm at the flat surface along a direction parallel to the optical axis is greater than a thickness of the arm at the bending surface along a direction parallel to the optical axis.

30. The camera module according to claim 22, wherein the arm has a bending surface located closer to the optical axis than the first contacting surface and the second contacting surface, and a thickness of the arm along a direction parallel to the optical axis gradually increases from a position where the bending surface is located towards a position where the first contacting surface is located;
wherein a minimum thickness of the arm at the bending surface along a direction parallel to the optical axis is T-bend, and the following condition is satisfied:
$$0.15 mm \leq T - bend \leq 1 mm .$$

31. The camera module according to claim 22, wherein the holder further has a first recess surface being disposed adjacent to the first contacting surface and being spaced apart from the arm;
wherein a distance in parallel with the optical axis between the first recess surface and the arm is G-holder, and the following condition is satisfied:
$$0.01 mm \leq G - holder \leq 0.4 mm .$$

32. The camera module according to claim 31, further comprising an insertion element disposed between the first recess surface and the arm.

33. The camera module according to claim 22, wherein the retainer further has a mounting portion through which the retainer is connected to the holder;
wherein a thickness of the arm in parallel with the optical axis between the first contacting surface and the second contacting surface is T-arm, a length in parallel with the optical axis between the second contacting surface and the mounting portion is L-2tomount, and the following condition is satisfied:
$$0.42 \leq T - arm / L - 2 tomount \leq 0.775 .$$

34. The camera module according to claim 22, wherein the holder further has a strengthening element overlapped with the first contacting surface along a direction parallel to the optical axis.

35. The camera module according to claim 22, wherein the holder comprises:
a base; and
a holder carrier disposed on the base, wherein the holder carrier has the first contacting surface and a third contacting surface, and the holder carrier is in contact with the base through the third contacting surface;
wherein the retainer has a mounting portion through which the retainer is mounted on the base;
wherein the third contacting surface is located closer to the arm than the mounting portion.

36. The camera module according to claim 22, wherein a length of the second contacting surface along a plane in parallel with the optical axis is L-retainer, a length of the first contacting surface along a plane in parallel with the optical axis is L-holder, and the following condition is satisfied:
$$0.2 < L - retainer / L - holder < 5.$$

37. An electronic device comprising:
the camera module of claim 22.

38. A camera module comprising:
a lens assembly having a plurality of lens elements that are disposed along an optical axis;
a lens barrel carrying the lens assembly;
an arm extending from the lens barrel along a direction away from the optical axis;
an image sensor disposed on an image side of the lens assembly;
a holder on which the lens barrel is disposed so as to correspond the lens barrel to the image sensor, wherein the holder comprises:
a base; and
a holder carrier disposed on the base, wherein the holder carrier has a first contacting surface surrounding the optical axis and being in contact with the arm, and the holder carrier carries the lens barrel through the first contacting surface; and
a retainer fixed on the holder so as to fix the lens barrel to the holder, wherein the retainer has a second contacting surface and a mounting portion, the second contacting surface surrounds the optical axis and is in contact with the arm, and the retainer is mounted on the base through the mounting portion;
wherein the arm is disposed between the holder and the retainer;
wherein one of the arm, the holder and the retainer is made of a material different from that of the other two of the arm, the holder and the retainer;
wherein the first contacting surface and the second contacting surface are non-overlapped with each other in a direction parallel to the optical axis.

39. The camera module according to claim 38, wherein a distance between the optical axis and a side of the first contacting surface close to the second contacting surface is D-1tocenter, a distance between the optical axis and a side of the second contacting surface close to the first contacting surface is D-2tocenter, and the following condition is satisfied:
$$0.01 \leq \vert D - 1 tocenterD - D - 2 tocenter \vert / ( D - 1 tocenter + D - 2 tocenter ) \leq 0.145 .$$

40. The camera module according to claim 38, wherein the holder carrier has an extension portion;
wherein a coefficient of thermal expansion of the extension portion is α-extension, a coefficient of thermal expansion of the retainer at 25° C. is α-retainer25, and the following condition is satisfied:
$$30 ppm / ° C . \leq α - extension - α - retainer 25 \leq 240 ppm / ° C .$$

41. The camera module according to claim 38, wherein a coefficient of thermal expansion of the lens barrel at 25° C. is α-barrel25, a coefficient of thermal expansion of the retainer at 25° C. is α-retainer25, and the following condition is satisfied:
$$α - retainer 25 < α - barrel 25.$$

42. The camera module according to claim 38, wherein a thickness of the arm in parallel with the optical axis between the first contacting surface and the second contacting surface is T-arm, and the following condition is satisfied:
$$0.15 mm \leq T - arm \leq 1.5 mm .$$

43. The camera module according to claim 38, wherein the arm has a bending surface located closer to the optical axis than the first contacting surface and the second contacting surface,
wherein a minimum thickness of the arm at the bending surface along a direction parallel to the optical axis is T-bend, a thickness of the arm in parallel with the optical axis between the first contacting surface and the second contacting surface is T-arm, and the following condition is satisfied:
$$0.333 \leq T - bend / T - arm \leq 0.885 .$$

44. The camera module according to claim 43, wherein the arm further has a flat surface being perpendicular to the optical axis and being located closer to the optical axis than the bending surface, and a thickness of the arm at the flat surface along a direction parallel to the optical axis is greater than a thickness of the arm at the bending surface along a direction parallel to the optical axis.

45. The camera module according to claim 38, wherein the arm has a bending surface located closer to the optical axis than the first contacting surface and the second contacting surface, and a thickness of the arm along a direction parallel to the optical axis gradually increases from a position where the bending surface is located towards a position where the first contacting surface is located;
wherein a minimum thickness of the arm at the bending surface along a direction parallel to the optical axis is T-bend, and the following condition is satisfied:
$$0.15 mm \leq T - bend \leq 1 mm .$$

46. The camera module according to claim 38, wherein the holder further has a first recess surface being disposed adjacent to the first contacting surface and being spaced apart from the arm;
wherein a distance in parallel with the optical axis between the first recess surface and the arm is G-holder, and the following condition is satisfied:
$$0.01 mm \leq G - holder \leq 0.4 mm .$$

47. The camera module according to claim 46, further comprising an insertion element disposed between the first recess surface and the arm.

48. The camera module according to claim 38, wherein a thickness of the arm in parallel with the optical axis between the first contacting surface and the second contacting surface is T-arm, a length in parallel with the optical axis between the second contacting surface and the mounting portion is L-2tomount, and the following condition is satisfied:
$$0.042 \leq T - arm / L - 2 tomount \leq 0.775 .$$

49. The camera module according to claim 38, wherein the holder carrier further has a strengthening element overlapped with the first contacting surface along a direction parallel to the optical axis.

50. The camera module according to claim 38, wherein a length of the second contacting surface along a plane in parallel with the optical axis is L-retainer, a length of the first contacting surface along a plane in parallel with the optical axis is L-holder, and the following condition is satisfied:
$$0.2 < L - retainer / L - holder < 5.$$

51. An electronic device comprising:
the camera module of claim 38.

52. A camera module comprising:
a plurality of lens elements disposed along an optical axis;
a lens barrel having a cylindrical wall that surrounds the plurality of lens elements;
an arm extending from the cylindrical wall of the lens barrel along a direction away from the optical axis, wherein the arm has an arm top surface facing towards an object side and an arm bottom surface facing towards an image side;
an image sensor disposed on an image side of the lens barrel;
a holder on which the lens barrel is disposed, wherein the holder comprises:
a base having a bottom portion and a surrounding wall, wherein the bottom portion has a bottom surface facing towards the arm, the surrounding wall extends from the bottom surface of the bottom portion towards the arm, and the surrounding wall has a surrounding top surface facing towards the arm and a surrounding inner surface facing towards the lens barrel; and
a holder carrier connected to the base, wherein the holder carrier has:
a strengthening element comprising a first abutting portion, a connecting portion and a second abutting portion, wherein the first abutting portion abuts on the surrounding top surface, the connecting portion extends from the first abutting portion along a direction away from the arm, the second abutting portion is connected to the connecting portion, and the second abutting portion is located further away from the arm than the first abutting portion; and
an extension portion having a first end connected to the second abutting portion and a second end extending from the first end towards the arm, wherein the second end is in contact with the arm bottom surface and forms a first contacting surface; and
a retainer fixed on the holder, wherein the retainer abuts on the arm top surface and forms a second contacting surface,
wherein a length of the surrounding inner surface along a direction parallel to the optical axis is L-toruinsidesurface, a length of the bottom surface along a direction parallel to the optical axis is L-downsidesurface, and the following condition is satisfied:
$$L - toruinsidesurface > L - downsidesurface .$$

53. The camera module according to claim 52, wherein a distance between the optical axis and a side of the first contacting surface close to the second contacting surface is D-1tocenter, a distance between the optical axis and a side of the second contacting surface close to the first contacting surface is D-2tocenter, and the following condition is satisfied:
$$0.05 mm \leq \vert D - 1 tocenter - D - 2 tocenter \vert \leq 1.8 mm .$$

54. The camera module according to claim 52, wherein the holder carrier has a third contacting surface through which the holder carrier is in contact with the base, the first end of the extension portion is in contact with the strengthening element and forms a fourth contacting surface, and the fourth contacting surface is located closer to the arm than the third contacting surface.

55. The camera module according to claim 52, wherein the strengthening element is located between the extension portion and the surrounding wall.

56. The camera module according to claim 52, wherein the holder has a first recess surface facing towards the arm, and the first recess surface is disposed being adjacent to the first contacting surface and being spaced apart from the arm.

57. The camera module according to claim 56, further comprising an insertion element disposed on the first recess surface.

58. An electronic device comprising:
the camera module of claim 52.
